(19) United States
(12) Patent Application Publication
(10) Pub. No.: US 2025/0217878 A1
(43) Pub. Date: Jul. 3, 2025

(54) COMPUTER SYSTEMS AND METHODS FOR DETERMINING AND APPLYING DEPOSIT LIMITS

(71) Applicant: Discover Financial Services, Riverwoods, IL (US)

(72) Inventors: Xiancheng Lu, Lincolnshire, IL (US); Tongjie Li, Northbrook, IL (US); Pradeep Vallanur Ramesh, Kildeer, IL (US)

(21) Appl. No.: 18/400,446

(22) Filed: Dec. 29, 2023

(51) Int. Cl. G06Q 40/02

(52) U.S. Cl. CPC G06Q 40/02

(57) ABSTRACT

A computing platform is configured to (i) use a deposit limit model to determine a deposit limit for an account holder of one or more deposit accounts, wherein the deposit limit comprises a monetary limit on a cumulative amount of deposits that the account holder is permitted to make into one or more deposit accounts during a time window, (ii) receive, from a client device associated with the account holder, an indication of a request from the account holder to make a new deposit into a deposit account, (iii) determine whether the deposit limit for the account holder is violated by the new deposit, and (iv) either (a) accept the new deposit if the deposit limit for the account holder is not violated by the new deposit or (b) reject the new deposit if the deposit limit for the account holder is violated by the new deposit.

### BACKGROUND

Financial institutions may offer certain types of financial accounts that allow customers to make deposits into the accounts. These types of financial accounts, which may be referred to as “deposit accounts,” may include checking accounts, saving accounts, and money market accounts, among other examples.

Many types of deposits into a deposit account involve a payment being made from a paying party to the party that holds the deposit account, examples of which may include a check deposit, an ACH deposit, or the like, and the processing of these types of deposits typically involves an electronic transfer of funds from a financial institution associated with the paying party to the financial institution maintaining the deposit account. However, for various reasons, it is possible that the payment underlying such a deposit is rejected or returned, which can cause a host of problems for both the financial institution maintaining the deposit account where the deposit was made and the financial institution associated with the paying party.

### OVERVIEW

Disclosed herein is new technology for determining and applying a “deposit limit” to an account holder's one or more deposit accounts.

In one aspect, the disclosed technology may take the form of a method to be carried out by a computing platform that involves (i) using a given deposit limit model to determine a deposit limit for an account holder of one or more deposit accounts based on data related to the account holder, wherein the deposit limit comprises a monetary limit on a cumulative amount of deposits of a given class that the account holder is permitted to make into one or more deposit accounts during a given time window, (ii) receiving, from a client device associated with the account holder, an indication of a request from the account holder to make a new deposit into a given deposit account of the one or more deposit accounts, (iii) determining whether the deposit limit for the account holder is violated by the new deposit, and (iv) either (a) accepting the new deposit if the deposit limit for the account holder is not violated by the new deposit or (b) rejecting the new deposit if the deposit limit for the account holder is violated by the new deposit.

The method may further involve additional functionality. For example, the method may additionally involve using the given deposit limit model to update the deposit limit for the account holder based on updated data related to the account holder. As another example, the given deposit limit model may be a first deposit limit model that is configured to receive data for a first set of input variables, and the method may additionally involve using a second deposit limit model to update the deposit limit for the account holder based on updated data related to the account holder, wherein the second deposit limit model is configured to receive data for a second set of input variables that differs from the first set of input variables. As yet another example, the method may additionally involve configuring the given deposit limit model based on configuration settings that are specified by a representative of the financial institution. The method may involve other functionality as well.

Further, the data related to the account holder may include various types of data. For instance, as one possibility, the data related to the account holder may include data related to a consumer history of the account holder. As another possibility, the data related to the account holder may include data related to deposit account activity of the account holder. Various other possibilities may also exist.

Further yet, the data related to the account holder may include one or more of (i) data that is retrieved from the data storage, (ii) data that is received from a third-party data source, or (iii) data that is derived from source data.

Still further, the given deposit limit engine may take various forms. For instance, the given deposit limit engine may include (i) a given set of input variables, (ii) one or more weight values corresponding to one or more of the given set of input variables, and (iii) one or more operators. The given deposit limit engine may take various other forms as well.

Still further, the deposit limit may take various forms. As one possibility, the deposit limit may include a fixed value. In practice, the fixed value may be selected from a predefined set of deposit limit tiers. As another possibility, the deposit limit may include a customized value, and in practice, the customized value may be computed for the account holder. Various other possibilities may also exist.

In another aspect, disclosed herein is a computing platform that includes at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In yet another aspect, disclosed herein is a non-transitory computer-readable medium comprising program instructions that are executable to cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration including example computing platforms operated by financial institutions, according to aspects of the disclosed technology.

FIG. 2 depicts an example network configuration including an example computing platform operated by a financial institution that has been modified to include a deposit limit engine, according to aspects of the disclosed technology.

FIG. 3 is a flow diagram that illustrates example functionality for configuring the deposit limit engine of FIG. 2, in accordance with the present disclosure.

FIG. 4 is a flow diagram that illustrates example functionality for determining and applying a deposit limit for a given account holder, in accordance with the present disclosure.

FIG. 5 is a simplified block diagram that illustrates some structural components of an example computing platform that may be configured to carry out any of the various functions disclosed herein.

FIG. 6 is a simplified block diagram that illustrates some structural components of an example client device that may be configured to carry out any of the various functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

As noted above, financial institutions may offer certain types of financial accounts that allow customers to make deposits into the accounts. These types of financial accounts, which may be referred to as “deposit accounts,” may include checking accounts, saving accounts, and money market accounts, among other examples.

Many types of deposits into a deposit account are based on a payment being made from a paying party to the party that holds the deposit account, and the processing of these types of deposits typically involves an electronic transfer of funds from a financial institution associated with the paying party to the financial institution maintaining the deposit account. In these scenarios, the paying party may be referred to as the “payor,” and the party that holds the deposit account may be referred to as either the “account holder” or the “payee.”

One example of this type of deposit is a check deposit, which is based on a payment from a payor of a check to the payee that is depositing the check into his or her deposit account. According to one typical workflow, processing such a deposited check involves an electronic transfer of funds between the financial institution maintaining the deposit account where the check is deposited by the payee (which may be referred to herein as the “deposit financial institution”) and a financial institution associated with the payor (which may be referred to herein as the “paying financial institution”) via a third-party intermediary that is involved in clearing checks, such as a local clearinghouse exchange, the Federal Reserve Bank, a credit union, or a correspondent bank, among other possibilities. In this respect, the deposit financial institution, the paying financial institution, and the third-party intermediary may each operate a respective computing platform that is involved in the workflow for processing a deposited check.

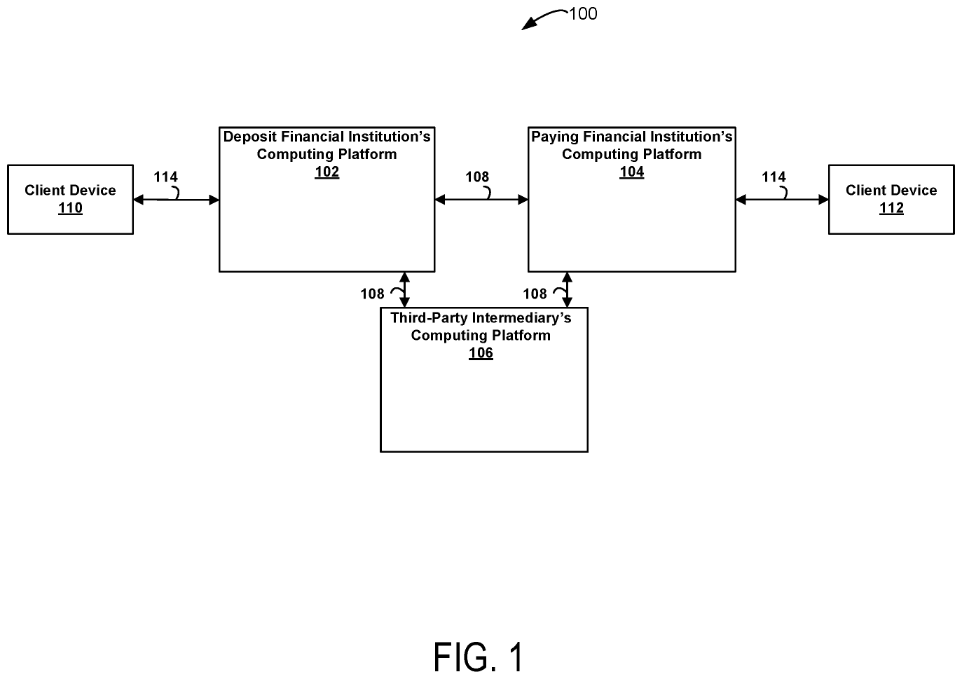

To illustrate with an example, FIG. 1 depicts an example network environment 100 comprising computing platforms that may be involved in processing a deposited check. As shown, the example network environment 100 includes an example computing platform 102 operated by a deposit financial institution, an example computing platform 104 operated by a paying financial institution, and an example computing platform 106 operated by a third-party intermediary involved in clearing checks (e.g., local clearing house exchange, the Federal Reserve Bank, a credit union, etc.).

In general, each of the computing platforms 102, 104, and 106 may comprise one or more computer systems (e.g., one or more servers) that have been installed with software for carrying out certain functionality related to processing checks (among various other software installed on such computing platforms). Further, in practice, the one or more computer systems of each of the computing platforms 102, 104, and 106 may collectively comprise some set of physical computing resources (e.g., one or more processors, data storage system, communication interfaces, etc.), which may take any of various forms. As one possibility, such a computing platform may comprise cloud computing resources supplied by a third-party provider of “on demand” cloud computing resources, such as Amazon Web Services (AWS), Amazon Lambda, Google Cloud, Microsoft Azure, or the like. As another possibility, such a computing platform may comprise “on-premises” computing resources of the given software provider (e.g., servers owned by the given software provider). As yet another possibility, such a computing platform may comprise a combination of cloud computing resources and on-premises computing resources. Other implementations of the computing platforms 102, 104, and 106 are possible as well.

As shown in FIG. 1, the computing platforms 102, 104, 106 may communicate with each other via respective communication paths 108. Each of these respective communication paths 108 may generally comprise one or more data networks and/or data links, which may take any of various forms. For instance, each respective communication path 108 may include any one or more of a Personal Area Networks (PAN), a Local-Area Networks (LAN), a Wide-Area Networks (WAN) such as the Internet or a cellular network, cloud network, and/or a point-to-point data link, among other possibilities, where each such data network and/or data link may be wireless, wired, or some combination thereof, and may carry data according to any of various different communication protocols. Although not shown, the respective communication paths 108 between the computing platforms 102, 104, and 106 may also include one or more intermediate systems, examples of which may include a data aggregation system and host server, among other possibilities. Many other configurations are also possible.

The example network environment 100 may additionally include client devices operated by individuals that are interested in interacting with one or more of the computing platforms 102, 104, and 106, examples of which may include account holders of the financial institutions, representatives (e.g., employees) of the financial institutions, and representatives (e.g., employees) of the third-party intermediary. For instance, as further shown in FIG. 1, the example network environment 100 may also include (i) a first representative client device 110 operated by an individual that interacts with the deposit financial institution (e.g., a payee of a check who holds a deposit account with the deposit financial institution, and (ii) a second representative client device 112 operated by an individual that interacts with the paying financial institution (e.g., a payor of a check to be deposited who is a customer of the paying financial institution). In general, each of the client devices 110 and 112 may include hardware components such as one or more processors, data storage, one or more communication interfaces, and input/output (I/O) components, among other possible hardware components, as well as software that facilitates the client device's ability to interact with one or more of the computing platforms 102, 104, and 106 in order to access the services provided by the one or more computing platforms (e.g., operating system software, web browser software, a mobile application, etc.). As representative examples, each of the client devices 110 and 112 could be any of a smartphone, a tablet, a laptop, or a desktop computer, among other possibilities.

The deposit financial institution's computing platform 102 and the paying financial institution's computing platform 104 may communicate with client devices (e.g., client devices 110 and 112, respectively) over respective communication paths 114. Each of these respective communication paths 114 may generally comprise one or more data networks and/or data links, which may take any of various forms. For instance, each respective communication path 114 may include any one or more of a PAN, a LAN, a WAN such as the Internet or a cellular network, a cloud network, and/or a point-to-point data link, among other possibilities, where each such data network and/or data link may be wireless, wired, or some combination thereof, and may carry data according to any of various different communication protocols. Although not shown, the respective communication paths 114 may also include one or more intermediate systems, examples of which may include a data aggregation system and host server, among other possibilities. Many other configurations are also possible.

While the example network environment 100 is shown to include a single client device 110 interacting with the deposit financial institution's computing platform 102 and a single client device 112 interacting with the paying financial institution's computing platform 104, it should be understood that in practice, there will be many different client devices that interact with the computing platforms 102 and 104 including but not limited to client devices operated by account holders of the financial institutions, representatives of the financial institutions (e.g., employees), etc. Likewise, although not shown, it should be understood that there may be client devices that interact with the third-party intermediary's computing platform 106 as well, such as client devices operated by representatives of the third-party intermediary (e.g., employees).

It should be understood that the example network environment 100 is one example of a network configuration in which embodiments described herein may be implemented, and numerous other arrangements are possible and contemplated herein. For instance, other network configurations may include additional components not pictured and/or more or less of the pictured components.

In the example network environment 100 of FIG. 1, when a check is deposited by the payee, the processing workflow for the deposited check may begin with the deposit financial institution's computing platform 102 transmitting an electronic representation of the deposited check over the communication path 108 to the third-party intermediary's computing platform 106. In practice, the electronic representation of a deposited check could be generated in various ways, such as by a scanner operated by an employee of the deposit financial institution, by software running on the client device 110 of the payee (e.g., a mobile check deposit software), or by software running on the deposit financial institution's computing platform 102, among other possibilities. Further, in practice, the electronic representation of the deposited check may be sent to the third-party intermediary's computing platform 106 along with a collection of a plurality of electronic representations of other deposited checks (e.g., other checks deposited at the deposit financial institution that day).

The third-party intermediary's computing platform 106 may then perform certain tasks for processing the deposited check and, in particular, for the purpose of clearing the check. In an example, the paying financial institution and the deposit financial institution may each have an account with this third-party intermediary. Upon receiving the electronic representation of the deposited check, the third-party intermediary's computing platform 106 may identify the paying financial institution (i.e., the financial institution from which the check is drawn) and then send the electronic representation of the deposited check (perhaps along with electronic representations of other checks) to the paying financial institution over the communication path 108.

After receiving the electronic representation of the deposited check, the paying financial institution's computing platform 104 then performs tasks for processing the check, such as matching up the deposited check with the paying financial institution's customer account of the payor and debiting the customer account of the payor, so that the customer account is updated to reflect that the check was processed. In an example, if the processing conducted by the paying financial institution reveals that the customer account had insufficient funds for the deposited check, the paying financial institution may send a notification of insufficient funds to the third-party intermediary. Additional tasks performed by the paying financial institution for processing checks are possible as well. For instance, the tasks performed by the paying financial institution for processing checks may further include fraud detection, error checking, duplicate detection, and/or notification tasks associated with given checks (e.g., large dollar notification (LDN) tasks associated with one or more checks over a threshold amount), among other possibilities. Along similar lines, the paying financial institution's computing platform 104 may perform these tasks for electronic representations of other checks that are received from the third-party intermediary's computing platform 106.

After the paying financial institution's computing platform 104 performs the foregoing tasks for processing the check, the paying financial institution's computing platform 104 may send the third-party intermediary's computing platform 106 a confirmation that the paying financial institution will honor the check. In response to receiving the confirmation that the paying financial institution will honor the check, the third-party intermediary's computing platform 106 may then debit funds from the account associated with the payor institution and credit funds to the account associated with the payee institution.

Other tasks performed by the computing platforms 102, 104, and 106 for the purpose of clearing a deposited check are possible as well. Further, other example workflows for electronic processing of a check are possible as well.

In some cases, it is also possible that the deposit financial institution's computing platform 102 may transmit the electronic representation of the deposited check to the paying financial institution's computing platform 104 rather than to the third-party intermediary's computing platform 106. For example, for a given deposited check, the paying financial institution may be a correspondent financial institution of the deposit financial institution (e.g., the deposit financial institution and the paying financial institution may be engaged in a partnership with one another). Thus, for the given deposited check, the deposit financial institution may bypass the third-party intermediary (e.g., the regional branch of the Federal Reserve Bank) and clear the check directly with the paying financial institution. In another example, the account of the payee and the account of the payor may both be maintained by the same financial institution, in which case the check may be cleared internally by that financial institution.

Other types of deposits that are based on a payment from a payor to a payee that is making the deposit are possible as well. For instance, another example of this type of deposit is an ACH-based deposit, which is based on a payment from a payor of the ACH transaction to a payee of the ACH transaction that has at least one deposit account with a deposit financial institution. As with a check deposit, processing of such an ACH-based deposit typically involves an electronic transfer of funds from a paying financial institution associated with the payor of the ACH transaction to a deposit financial institution maintain a deposit account of the payee of the ACH transaction via a third-party intermediary, which in this example is an ACH network.

It will be understood that these are just a few examples of the types of deposits that may be made into deposit accounts, and other types of deposits are possible as well.

The ability to make deposits that involve a transfer of funds from a paying financial institution to a deposit financial institution, such as check deposits and ACH-based deposits, is fundamental to the customer experience for deposit accounts. Indeed, if a financial institution did not permit its customers to make these types of deposits in their deposit accounts, that would significantly degrade the usefulness of the deposit accounts, and customers would quickly begin looking to move their business to alternative financial institutions where these types of deposits were permitted. Thus, most financial institutions that offer deposit accounts have little choice but to allow their customers to make these types of deposits.

However, at the same time, deposits that involve a transfer of funds from a paying financial institution to a deposit financial institution, such as check deposits and ACH-based deposits, present a risk that the funds underlying the deposit either (i) cannot be collected from the paying financial institution at all or (ii) must be returned to the paying financial institution after the deposit has been accepted by the deposit financial institution-which is typically not known to the deposit financial institution until several days after the deposited has been accepted and the funds have been credited to the account holder's deposit account.

For example, after a check deposit is accepted into a deposit account maintained by the deposit financial institution, the deposit financial institution may learn that the check cannot be successfully processed and that the funds cannot be collected from the paying financial institution, or that the funds must be returned to the paying financial institution. This could happen days or even weeks after the deposit for any of various reasons, examples of which may include that the payor is deemed to have insufficient funds, the payor does not have a valid account (or at least no longer has an active account) with the paying financial institution, the payor has requested a stop payment order, the payor disputes that it ever authorized transaction, or there is a concern that the check presents a fraud risk, among other possible reasons why the deposit financial institution is unable to collect (or must return) the funds underlying a check after it has been accepted into a deposit account.

As another example, after an ACH-based deposit is accepted into a deposit account maintained by the deposit financial institution, the deposit financial institution may learn that the ACH transaction has been rejected and that the funds either cannot be collected from the paying financial institution or must be returned to the paying financial institution. As with a rejected check deposit, this could happen days or even weeks after the deposit for any of various reasons, examples of which may include that the payor is deemed to have insufficient funds, the payor does not have a valid account (or at least no longer has an active account) with the paying financial institution, the payor has requested a stop payment order or a refund, the payor disputes that it ever authorized transaction, or there is a concern that the ACH transaction presents a fraud risk, among other possible reasons why the deposit financial institution is unable to collect (or must return) the funds underlying a ACH-based deposit after it has been accepted into a deposit account.

Other deposit types could also present a similar risk that the funds underlying the deposit either cannot be collected from the paying financial institution or must be returned to the paying financial institution after the deposit has been accepted by the deposit financial institution.

In practice, the level of risk of non-collection or return presented by any given deposit may vary depending on factors such as the type of deposit (e.g., check, ACH deposit type, etc.), the circumstances under which the deposit was made (e.g., in person versus remote), and the parties involved in the payment transaction upon which the deposit is based, among others. However, because a deposit financial institution that typically handles a large volume of deposits (e.g., on the order of hundreds of thousands, millions, or more per year), it is almost unavoidable that such a deposit financial institution will run into its share of circumstances where the funds underlying a deposit made by an account holder either cannot be collected from the paying financial institution or must be returned to the paying financial institution.

Unfortunately, when a deposit financial institution either cannot collect the funds underlying a deposit from the paying financial institution or must return the funds to the paying financial institution, this leads to a host of negative consequences that impact the deposit financial institution and/or its account holders.

For instance, as noted above, the deposit financial institution may not learn that the funds underlying the deposit either cannot be collected from the paying financial institution or must be returned to the paying financial institution until several days or weeks after the deposit financial institution has already credited the funds to the account holder's deposit account, and in at least some scenarios, the account holder may have already withdrawn and spent the credited funds. For example, an individual could open a new deposit account with the deposit financial institution, make a deposit into the account knowing that it is faulty, and then immediately withdraw and spend the credited funds before the deposit financial institution becomes aware of the issue. In these scenarios, it may be difficult or impossible for the deposit financial institution to recover the funds from the account holder, which means that the deposit financial institution may have to cover the non-collected or returned funds itself. This imposes a financial loss on the deposit financial institution that will grow as the number of faulty deposits grows. Moreover, even if the deposit financial institution is able to recover the funds from the account holder after the fact, this may still give rise to other negative consequences, such as unhappy customers, additional operational costs, and/or damage to the deposit financial institution's reputation (e.g., becoming labeled as an “easy target” for individuals seeking to make faulty deposits and then withdraw the funds before the deposit financial institution becomes aware of the issue).

Moreover, when a deposit financial institution either cannot collect the funds underlying a deposit from the paying financial institution or must return the funds to the paying financial institution, this typically requires the deposit financial institution to expend resources that would otherwise not be necessary if the faulty deposit had not been made. For example, upon determining that the funds underlying a deposit either cannot be collected or must be returned, the deposit financial institution's computing platform will typically be required to carry out additional functionality responsive to that determination that would otherwise not be required had the faulty deposit had not been made-including additional communications with the computing platform of the third-party intermediary and/or the paying financial institution-which utilizes additional compute resources and reduces the efficiency of the computing platform. In addition, deposit financial institution may need to devote additional employee time or expend additional administrative costs as a result of the fact that the funds underlying a deposit cannot be collected or must be returned.

As the number of faulty deposits received by a deposit financial institution increases over time, these negative consequences become compounded and can lead to substantial loss by the deposit financial institution (e.g., monetary loss, customer loss, reputational damage, etc.) as well as degradation in the efficiency and performance of the deposit financial institution's computing platform, among other possible problems caused by these faulty deposits.

Thus, there is a need for a solution that helps a deposit financial institution reduce the risk of accepting these kinds of faulty deposits where the funds underlying the deposits either cannot be collected from a paying financial institution or must be returned to the paying financial institution after the deposit has been accepted by the deposit financial institution, while at the same time delivering an acceptable level of customer experience to account holders of deposit accounts. Indeed, if a deposit financial institution imposes restrictions that make it more difficult for account holders to use their deposit accounts, those account holders are likely to become unhappy and start looking at alternative options for their deposit account needs. This is particularly the case for account holders that keep large balances in their deposit accounts and have a strong track record with the deposit financial institution-which are typically the account holders that are most valuable to a financial institution. This need for a solution that balances between reducing the risk of accepting faulty deposits and delivering an acceptable customer experience is complicated by the fact that a deposit financial account typically maintains a larger volume of deposit accounts (e.g., on the order of thousands or perhaps even millions) and typically handles an even larger volume of deposits (e.g., on the order of hundreds of thousands, millions, or more per year). Because of these large volumes, it is not practically possible to have the human employees of a deposit financial institution oversee and manage the risk of the deposits being made by the deposit financial institution's account holders. Rather, the only practical solution is to provision a deposit financial institution's computing platform with software technology that is capable of overseeing and managing the risk deposits made by the deposit financial institution's account holders.

To address these and other problems, disclosed herein is software technology for determining and applying a “deposit limit” to an account holder's one or more deposit accounts, which as used herein refers to a monetary limit on a cumulative amount of deposits of a given class that the account holder is permitted to make during a given time window.

In general, the given time window to which an account holder's deposit limit applies may comprise some defined period of time that encompasses the current time when the deposit limit is being determined and/or applied. For example, the given time window to which the deposit limit applies may comprise some multi-day period that encompasses the current time when the deposit limit is being determined and/or applied, such as the current month, the current week, or the current fortnight, among other examples. In this respect, the given time window to which the deposit limit applies may change or “slide forward” over time once the current time extends past (and is no longer encompassed by) the previous time window, and when the given time window changes, the cumulative amount of deposits to which the deposit limit applies will typically “reset” back to $0. To illustrate with an example, if the given time window to which the deposit limit applies is the current calendar month (January), then when the current month ends (e.g., at 12:00 a.m. on February 1st), the given time window to which the deposit limit applies will change to the next calendar month in accordance with the fact that the current calendar month has changed (e.g., from January to February), and the cumulative amount of deposits to which the deposit limit applies will typically “reset” back to $0 to reflect that the account holder has not yet made any deposits of the given class in new calendar month. Many other examples are possible as well.

Further, in general, the given class of deposits to which an account holder's deposit limit applies may comprise some defined set of deposit types that a deposit financial institution wishes to restrict so as to reduce the risk of accepting deposits having underlying funds that either cannot be collected from a paying financial institution or must be returned to the paying financial institution after the deposit has been accepted by the deposit financial institution. In this respect, the given class of deposits to which the deposit limit applies may comprise a set of deposit types that are considered to present an increased risk of non-collection or return of the funds underlying the deposit. Examples of such deposit types may include check deposits and ACH-based deposits, among others. In some implementations, the deposit types that are included in the given class of deposits may also be defined in a more granular manner. For example, the given class of deposits could include certain types of check deposits that are considered to present a higher risk of non-collection or return (e.g., remote check deposits) while excluding other types of check deposits that are considered to present a lower risk of non-collection or return (e.g., in-person check deposits). As another example, the given class of deposits could include certain types of ACH-based deposits that are considered to present a higher risk of non-collection or return (e.g., ACH-based deposits that are not verified through a third-party vendor) while excluding other types of ACH-based deposits that are considered to present a lower risk of non-collection or return (e.g., ACH-based deposits that are verified through a third-party vendor). The given class of deposits to which the deposit limit applies may take various other forms as well.

Further yet, the deposit account(s) to which an account holder's deposit limit applies could take any of various forms. In one implementation, an account holder may be assigned a single deposit limit that is applicable to all deposit accounts held by the account holder. For instance, if the account holder has multiple deposit accounts with the deposit financial institution, the deposit limit is applied to the cumulative amount of deposits of the given class made across those multiple accounts during the given time window, whereas if the account holder only has a single deposit account with the deposit financial institution, the deposit limit is applied to the amount of deposits of the given class made into that one single account during the given time window. In another implementation, an account holder may be assigned a single deposit limit that is applicable to some subset of the deposit accounts held by the account holder, such as deposit accounts of some types but not others (e.g., only checking and savings accounts but not money market accounts). In yet another implementation, an account holder may be assigned a respective deposit limit for each of multiple deposit accounts held by the account holder. For instance, an account holder may be assigned a first deposit limit for a first deposit account (e.g., a checking account), a second deposit limit for a second deposit account (e.g., a saving account), and so on for any other deposit account held by the account holder. The deposit account(s) to which an account holder's deposit limit applies could take other forms as well.

In accordance with the present disclosure, a computing platform provisioned with the disclosed software technology may function to determine a deposit limit for an account holder based on certain data related to the account holder, which may take any of various forms. As some representative examples, a computing platform provisioned with the disclosed software technology may function to a deposit limit for an account holder based on one or more of (i) data related to one or more deposit accounts held by the account holder at the deposit financial institution (if the deposit limit is being determined at a time when such data exists), (ii) data related to the account holder's consumer history (e.g., a consumer report that is obtained from a credit bureau or some other consumer reporting agency such as Early Warning Services, ChexSystems, or the like), (iii) data related to the account holder's personal background, and/or (iv) data related to one or more other types of financial accounts held by the account holder at the deposit financial institution (e.g., credit account, mortgage account, loan account, etc.), among other possible types of data related to the account holder that may be utilized to determine the deposit limit for the account holder in accordance with the present disclosure. In this respect, certain data that is utilized to calculate the deposit limit may be determined from source data that is already stored at the computing platform installed with the disclosed software technology (e.g., the deposit financial institution's computing platform), while other data that is utilized to calculate the deposit limit may be determined from source data that obtained from a third-party data source (e.g., a consumer reporting agency's computing platform).

Further, in accordance with the present disclosure, a computing platform provisioned with the disclosed software technology may start by making an initial determination of a deposit limit for an account holder at a first time, and may thereafter function to update the deposit limit for the account holder on some ongoing basis, such that the deposit limit for the account holder is “dynamic” in nature. In this respect, depending on when initial and updated determinations of the deposit limit for the account holder are made, the particular types of data that are utilized to make these determinations could differ. For instance, a computing platform provisioned with the disclosed software technology may be configured to determine deposit limit for an account holder based at least in part on data related to the account holder's deposit account history, but if the computing platform makes the initial determination of the deposit limit for the account holder at or around the time that the account holder opens his or her first deposit account with the deposit financial institution, there may not be any available data related to the account holder's deposit account history. As such, a computing platform provisioned with the disclosed software technology could be configured to utilize multiple different models to determine a deposit limit for an account holder that are based on different input datasets, such as (i) a first model that is configured to determine a deposit limit for an account holder at a time when there is not sufficient deposit account history for the account holder (e.g., when making an initial determination of the deposit limit), which may focus more heavily on data related to the account holder's consumer history, the account holder's personal background, and/or the account holder's other financial accounts (if any) with the deposit financial institution, and (ii) a second model that is configured to determine a deposit limit for an account holder at a time when there is sufficient deposit account history for the account holder (e.g., when making updated determinations of the deposit limit), which may focus more heavily on data related to the account holder's deposit account history but may also factor in other types of data related to the account holder as well. Many other implementations are possible as well.

Further yet, in accordance with the present disclosure, the functionality for determining a deposit limit for an account holder may involve either determining a deposit limit that takes the form of a fixed amount selected from a set of predefined tiers (e.g., $0, $500, $1000, $2000, $5000, $10000, $30000, etc.) or determining a deposit limit that takes the form of a customized amount that is specifically calculated for the account holder without reference to any predefined tier (e.g., $2350).

Still further, in accordance with the present disclosure, a computing platform provisioned with the disclosed software technology may make the initial and updated determinations of a deposit limit for an account holder at any of various times. For instance, a computing platform provisioned with the disclosed software technology may make the initial determination of a deposit limit for an account holder either at or around the time that the account holder opens a first deposit account with the deposit financial institution, or at some later time after the account holder has already developed some deposit account history with the deposit financial institution. In turn, a computing platform provisioned with the disclosed software technology may make updated determinations of the deposit limit for the account holder (i) in accordance with an “update frequency” (or “update rate”) dictating that the deposit limit is to be updated at predefined intervals, examples of which may include updating every hour (i.e., hourly), every several hours, every day (i.e., daily), every several days, every week (i.e., weekly), etc., and/or (ii) in response to certain trigger events (e.g., an account holder's request to make a new deposit, an account holder's request for an increased deposit limit, etc.).

To illustrate with an example, if the given time window to which the deposit limit applies is the current month, a computing platform provisioned with the disclosed software technology could be configured to update the deposit limit in accordance with an update frequency that is more frequent than monthly, such as daily or weekly (in which case the deposit limit may be updated one or more times during each applicable window of time), an update frequency that also monthly (in which case the deposit limit may be updated at the beginning of each new window), or an updated frequency is less frequent than monthly, such as quarterly (in which the deposit limit may only be updated during some windows and not others), perhaps along with any other “on demand” updates that are prompted by triggering events. The initial and updated determinations of a deposit limit for an account holder may be made at other times as well.

After initially determining or updating a deposit limit for an account holder, the computing platform provisioned with the disclosed software may also enable the account holder to access and view the deposit limit. For example, the computing platform may enable an account holder to access a graphical user interface (GUI) via a client device through which the account holder can view his or her current deposit limit (and perhaps also view past values of the deposit limit to see how it has chance). As another example, the computing platform may cause an account holder to be presented with a notification each time the account holder's deposit limit changes—or at least each time the account holder's deposit limit changes by a threshold amount. The computing platform may enable an account holder to access and view the account holder's deposit limit in other manners as well.

When a computing platform provisioned with the disclosed software technology receives a request from an account holder to make a new deposit, the computing platform may then apply the deposit limit that has been determined for the account holder to the newly-requested deposit, which may involve (i) determining whether the newly-requested deposit violates the deposit limit, and then (ii) deciding how to handle the newly-requested deposit (e.g., whether to reject or accept the newly-requested deposit) based on the determining. For instance, if the newly-requested deposit is not within the given class of deposits or otherwise will not cause a cumulative amount of deposits of the given class made by the account holder during the given time window to exceed the deposit limit, the computing platform may determine that the deposit limit is not violated and decide to accept the newly-requested deposit. On the other hand, if the newly-requested deposit will cause the cumulative amount of deposits of the given class made by the account holder during the given time window to exceed the deposit limit, the computing platform may determine that the deposit limit is violated and decide to reject the newly-requested deposit.

A computing platform provisioned with the disclosed software technology may then continue to apply the deposit limit to new deposits that are requested by the account holder during the current time window (while perhaps also updating the deposit limit at certain points during the current time window). When the end of the current time window is reached (e.g., the current month comes to an end), the computing platform may then switch over and begin applying the deposit limit to a new time window (e.g., the new month) and may also “reset” the cumulative amount of deposits to which the deposit limit applies to $0 to reflect that the deposit limit is being applied to a new time window. In some implementations, the computing platform may also be configured to make an updated determination of the deposit limit when switching to the new time window, while in other implementations, the functionality of switching to the new time window may be carried out without also making an updated determination of the deposit limit at that point in time (in which case the computing platform may apply a previously-determined deposit limit to new deposits requested during the new time window unless and until a next updated determination of the deposit limit is made).

In accordance with the present disclosure, a computing platform provisioned with the disclosed software technology may utilize a deposit limit that is determined for an account holder in other manners as well. For instance, a computing platform provisioned with the disclosed software technology could use a determined deposit limit for an account holder as an input into a model that is utilized to make some other kind of determination related to the account holder, such as a determination of whether to extend credit to the account holder or a determination of a level of risk presented by the account holder, among other possible ways that a computing platform could use a deposit limit that is determined for an account holder.

Thus, the disclosed software technology may advantageously allow a deposit financial institution to balance between reducing the risk of accepting faulty deposits where the funds underlying the deposits either cannot be collected or must be returned and delivering an acceptable level of customer experience to account holders of deposit accounts in an intelligent and automated manner that can be carried out at the scale necessary for the larger volume of account holders that are typically serviced by a deposit financial institution. In this way, the disclosed software technology improves over existing technology for setting deposits limits and processing deposits, which fail to take these considerations into account. And as a result, the disclosed software technology may enable a deposit financial institution to avoid (or at least reduce) the negative consequences discussed above (e.g., monetary loss, customer loss, reputational damage, degradation in the efficiency and performance of the deposit financial institution's computing platform, etc.).

In at least some implementations, the software technology disclosed herein may be implemented in the form of one or more software components installed at a computing platform of a financial institution that offers deposit accounts to its customers.

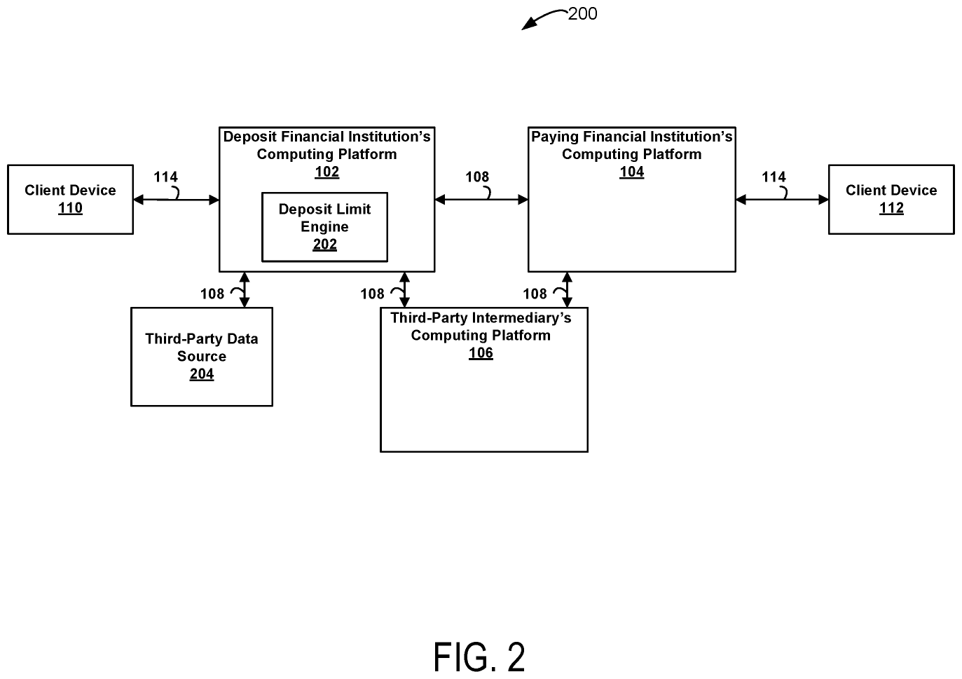

To illustrate with an example, FIG. 2 shows an updated version 200 of the network environment 100 of FIG. 1 in which the deposit financial institution's computing platform 102 has been modified to include a software component referred to as deposit limit engine 202 that is capable of carrying out the disclosed functionality for determining deposit limits for account holders of deposit accounts maintain by the deposit financial institution.

In operation, the deposit limit engine 202 may be configured with logic (e.g., one or more models) for determining respective deposit limits for account holders of interest, which could comprise all account holders having at least deposit account maintained by the financial institution or perhaps a particular subset of those account holders (e.g., account holders having deposit accounts of certain types, account holders that meet certain criteria for determining whether or not to utilize a deposit limit, etc.). For example, the account holders for which deposit limits are determined could include all account holders having at least one deposit account of a type that permits regular withdrawals, but could exclude account holders whose only deposit accounts are ones where regular withdrawals are prohibited (or at least restricted in some way), among other possible examples. Depending on the financial institution, this means that deposit limit engine 202 could be used to determine respective deposit limits for thousands or even millions of account holders in practice.

After the deposit limit engine 202 is configured, the deposit limit engine 202 may function to determine and maintain a respective deposit limit for each account holder of interest, which may involve the following functionality for each account holder of interest: (i) making an initial determination of the respective deposit limit for the account holder, and (ii) thereafter updating the respective deposit limit for the account holder in accordance with an update frequency (e.g., daily, weekly, monthly, etc.) and/or in response to certain triggering events (e.g., an account holder's request to make a new deposit, an account holder's request for an increased deposit limit, etc.).

When making the initial and/or updated determinations of the respective deposit limits each account holders of interest, the computing platform 102 may obtain certain source data that is utilized to make such determinations. In this respect, some source data may be stored at the computing platform 102, while other source data may be obtained from a third-party data source (e.g., a consumer reporting agency's computing platform), of which third-party data source 204 is shown in FIG. 2 as an example. In practice, the computing platform 102 may communicate with the example third-party data source 204 over a respective communication path 108. As with the other communication paths 108 described above, the respective communication path 108 between the computing platform 102 and the third-party data source 204 may generally comprise one or more data networks and/or data links, which may take any of various forms. For instance, each respective communication path 114 may include any one or more of a PAN, a LAN, a WAN such as the Internet or a cellular network, a cloud network, and/or a point-to-point data link, among other possibilities, where each such data network and/or data link may be wireless, wired, or some combination thereof, and may carry data according to any of various different communication protocols. Although not shown, the respective communication path 108 between the computing platform 102 and the third-party data source 204 may also include one or more intermediate systems, examples of which may include a data aggregation system and host server, among other possibilities. Many other configurations are also possible.

In at least some implementations, the deposit limit engine 202 may additionally function to apply the respective deposit limit for each account holder of interest to at least a subset of the deposits that are made by the account holder. For instance, when any account holder of interest requests to make a new deposit that falls within the class of deposits governed by the deposit limit, the deposit limit engine 202 may carry out functionality for determining whether the new deposit violates the current deposit limit for the account holder (e.g., by determining the cumulative amount of deposits of the given class that have been deposited within the given time window), and the computing platform 102 may then decide whether to accept or reject the new deposit based on that determination.

However, in other implementations, a software component other than the deposit limit engine 202 may be tasked with applying the respective deposit limits for account holders of interest to deposits made by such account holders. For example, the back-end computing platform's software pipeline for processing newly-requested deposits may be extended to include functionality for applying the disclosed deposit limits to newly-requested deposits. And in such implementations, the other software component may be configured to obtain respective deposit limits for account holders of interest from the deposit limit engine 202 (e.g., by making a call to the deposit limit engine 202) as new deposit requests are received by the back-end computing platform 102.

The software technology for determining and applying deposit limits for account holders could be implemented in various other manners as well.

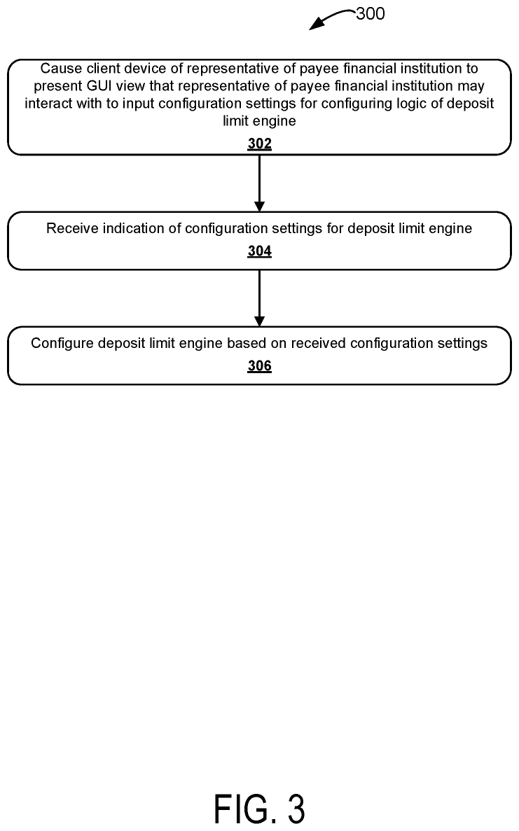

Turning now to FIG. 3, an example flow chart illustrating example functionality 300 for configuring a deposit limit engine in accordance with the present disclosure is shown. In practice, the example functionality 300 of FIG. 3 may be encoded in the form of program instructions that are executable by one or more processors of a computing platform, and for purposes of illustration, the example functionality 300 of FIG. 3 is described as being carried out by the deposit financial institution's computing platform 102 of FIG. 2 that has been installed with the example deposit limit engine 202, but it should be understood that the example functionality 300 of FIG. 3 may be carried out by any one or more computing platforms that are capable of being installed with software that provides the example functionality 300 of FIG. 3. Further, it should be understood that the example functionality 300 of FIG. 3 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 3, the example functionality 300 may begin at block 302 with the computing platform 102 causing a client device 110 of a representative of the deposit financial institution to present a GUI that the representative of the deposit financial institution may interact with to input configuration settings for the deposit limit engine 202 of the computing platform 102, which may be referred to herein as the “configuration GUI” of the deposit limit engine 202. In this respect, the configuration GUI may enable the representative of the deposit financial institution to input various configuration settings for the deposit limit engine 202, which may then be utilized by the deposit limit engine 202 when determining deposit limits for account holders of interest.

As one possibility, the configuration GUI may enable the representative of the deposit financial institution to specify a type of time window to which deposit limits determined by the deposit limit engine 202 are to be applied. For instance, the configuration GUI may enable the representative of the deposit financial institution to specify that deposit limits determined by the deposit limit engine 202 are to be applied to deposits made by account holders during the current calendar month, among other possible types of time windows that may be specified by the representative of the deposit financial institution (e.g., time windows having shorter or longer durations). In line with the discussion above, the deposit limit engine 202 may then identify the given time window to which the deposit limits determined by the deposit limit engine 202 are to be applied based on the specified type of time window, and may maintain an indication of that given time window (which may change over time as one time window ends and another time window begins).

As another possibility, the configuration GUI may enable the representative of the deposit financial institution to specify a given class of deposits that are to be governed by the deposit limits determined by the deposit limit engine 202. For instance, the configuration GUI may enable the representative of the deposit financial institution to specify that the deposit limits determined by the deposit limit engine 202 are to be applied to certain deposit types that present an increased risk of non-collection or return, examples of which may include (i) at least certain types of check deposits and/or (ii) at least certain types of ACH-based deposits, among other possible deposit types that may present an increased risk of non-collection or return.

As yet another possibility, the configuration GUI may enable the representative of the deposit financial institution to input configuration parameters for one or more models that are to be utilized by the deposit limit engine 202 to determine deposit limits for account holders, which may be referred to herein as “deposit limit models.” For instance, in accordance with the present disclosure, the configuration GUI may enable the representative of the deposit financial institution to input configuration parameters for (i) a first deposit limit model that is configured to determine a deposit limit for an account holder at a time when there is not sufficient deposit account history for the account holder and (ii) a second deposit limit model that is configured to determine a deposit limit for an account holder at a time when there is sufficient deposit account history for the account holder. The configuration parameters for each such deposit limit model may take various forms, and in at least some implementations, may include (i) input variables, (ii) weights, and (iii) operators, among various other possible configuration parameters (e.g., other types of configuration parameters for linear or non-linear models).

The input variables that the configuration GUI may enable the representative of the deposit financial institution to specify for a deposit limit model may take any of various forms. For instance, one category of input variables that may be specified for a deposit limit model may comprise input variables related to one or more deposit accounts held by an account holder for which a deposit limit is being determined. Some examples of such input variables related to an account holder's one or more deposit accounts may include (i) an input variable that indicates a current total balance in the applicable deposit account(s), (ii) an input variable that indicates a total or average amount of deposits of the given class that have been made by the account holder during a given lookback window (e.g., the past 2 months), (iii) an input variable that indicates a total amount of direct deposits made into the applicable deposit account(s) held by the account holder during a given lookback window (e.g., the past 2 months), (iv) an input variable that indicates a secured balance of the applicable deposit account(s) (e.g., an amount of funds in the applicable deposit account(s) that have remained in the one or more accounts, which may be determined by taking a difference between current total balance in the applicable deposit account(s) and total amount of deposits of the given class that have been made by the account holder during a given lookback window), and/or (v) an input variable that indicates how long the applicable deposit account(s) have been open. Many other examples of input variables related to one or more deposit accounts held by an account holder for which a deposit limit is being determined may exist as well, including but not limited to other input variables related to the account holder's recent deposit account activity.

Another category of input variables that may be specified for a deposit limit model may comprise input variables related to the consumer history of an account holder for which for which a deposit limit is being determined, which may be determined based on a consumer report that is obtained from a credit bureau or some other consumer reporting agency (e.g., Early Warning Services, ChexSystems, etc.) or some other type of third-party vendor data. Some examples of such input variables related to an account holder's consumer history may include (i) an input variable that indicates a credit score of the account holder (e.g., FICO score), which could be represented in terms of a numerical value of the credit score and/or in terms of a credit score range (or “band”) in which the credit score falls, (ii) an input variable that indicates a number of credit lines of the account holder that are currently open, (iii) an input variable that indicates how long a given credit line of the account holder has been open, which may be indicated as a numerical representation of the number of years (or other period of time) that the given credit line of the account holder has been open, and/or (iv) an input variable that indicates some other consumer-history metric available to the deposit financial institution (e.g., a consumer-history metric that was previously derived and stored by the deposit financial institution based on some combination of credit score, number of credit lines, and/or age of credit lines). Many other examples of input variables related to the consumer history of an account holder for which a deposit limit is being determined may exist as well.

Yet another category of input variables that may be specified for a deposit limit model may comprise input variables related to the personal background of an account holder for which for which a deposit limit is being determined. Some examples of such input variables related to an account holder's personal background may include (i) an input variable that indicates an age of the account holder, (ii) an input variable that indicates an occupation of the account holder, and/or (iii) an input variable that indicates an income of the account holder. Many other examples of input variables related to the personal background of an account holder for which a deposit limit is being determined may exist as well.

Still another category of input variables that may be specified for a deposit limit model may comprise input variables related to one or more other types of financial accounts held by an account holder for which for which a deposit limit is being determined (e.g., credit account, mortgage account, loan account, etc.). Some examples of such input variables related to an account holder's personal background may include (i) an input variable that indicates a balance of the other financial account(s) held by the account holder at the deposit financial institution (e.g., a mortgage balance, a loan debt, etc.), (ii) an input variable that indicates how long the other financial account(s) have been open, and/or (iii) an input variable that indicates the extent to which the account holder has missed payments on the other financial account(s). Many other examples of input variables related to other types of financial accounts held by an account holder for which a deposit limit is being determined may exist as well, including but not limited to other input variables related to the terms of the other financial account(s) (e.g., interest rate, loan/mortgage duration, etc.).

The input variables that may be specified for a deposit limit model may take other forms as well, including but not limited to the possibility that one of the input variables for a deposit limit model may be the current deposit limit, which may factor into the determination of an updated deposit limit. Further, in practice, the configuration GUI may enable the representative of the deposit financial institution to specify different sets of input variables for different deposit limit models, as explained in further detail below.

Additionally, along with the input variables, the configuration GUI may also enable the representative of the deposit financial institution to specify corresponding weights for the input variables, which may govern the relative contribution of each input variable to the determination of a deposit limit for an account holder. For instance, for each specified input variable of a deposit limit model, the configuration GUI may enable the representative of the deposit financial institution to specify corresponding weight that takes the form of a numerical coefficient (or other operand) that serves to normalize the value of the input variable in some way (so that it can then be used to calculate the deposit limit. In this respect, one input variable could be assigned a corresponding weight that is greater than 1, which serves to increase the value of that input variable by some specified amount (e.g., a weight ranging from 2 to 5), whereas another input variable could be assigned a corresponding weight that is less than 1, which serves to decrease the value of that input variable by some specified amount (e.g., a weight ranging from 0.1 to 0.5), and still another input variable may not be assigned any corresponding weight (or may be assigned a weight of 1), in which case decrease the value of that input variable will not be increased or decreased.

Additionally yet, along with the input variables and corresponding weights, the configuration GUI may also enable the representative of the deposit financial institution to specify operators that are to be applied to the (weighted) values of input variables in order to combine those values together to produce the deposit limit. For instance, one example of a type of operator that may be specified for a deposit limit model may comprise an aggregator function that determines the maximum, minimum, average, or summation of the (weighted) values of multiple input variables. Additionally, another example of a type of operator that may be specified for a deposit limit model may comprise a binary operator such as a plus operator, a minus operator, a multiplication operator, or a division operator between two (weighted) input variables (or between an input variable and a constant. Additionally yet, another example of a type of operator that may be specified for a deposit limit model may comprise a greater-than or less-than operator between two (weighted) input variables or between one (weighted) input variable and a constant value (e.g., a credit score threshold). The configuration GUI may enable the representative of the deposit financial institution to specify other types of operators as well.

The configuration parameters for a deposit limit model may take other forms as well. For instance, the configuration GUI may also enable the representative of the deposit financial institution to optionally input a set of predefined deposit limit tiers that are to be utilized by a deposit limit model when determining deposit limits for account holders (e.g., in implementations where the deposit limit engine 202 is configured to determine deposit limits that are mapped to predefined tiers). In practice, the set of predefined deposit limit tiers may include any number of tiers. As one example, the set of deposit limit tiers may include a first tier with a deposit limit of $500, a second tier with a deposit limit of $1,000, a third tier with a deposit limit of $2,000, a fourth tier with a deposit limit of $5,000, a fifth tier with a deposit limit of $10,000, a sixth tier with a deposit limit of $20,000, and a seventh tier with a deposit limit of $50,000. However, there may be more or fewer deposit limit tiers in the set, and the monetary values of the deposit limit tiers may be more or less than those shown in this example.

In implementations where the deposit limit engine 202 is configured to utilize a set of deposit limit tiers to determine deposit limits, the deposit limit engine 202 may perform such a determination in various ways. As one example, the deposit limit engine 202 may be configured to round a calculated deposit limit up to a nearest deposit limit of the set of deposit limit tiers. As another example, the deposit limit engine 202 may be configured to round a calculated deposit limit down to a nearest deposit limit of the set of deposit limit tiers. As yet another example, the deposit limit engine 202 may be configured to round a calculated deposit limit to a nearest deposit limit of the set of deposit limit tiers, either up or down. The deposit limit engine 202 may utilize the deposit limit tiers in various other ways as well.

Further, the configuration GUI may enable the representative of the deposit financial institution to optionally input a restriction on the extent to which the deposit limit determined by a deposit limit model may change relative to its prior value. For instance, the configuration GUI may enable the representative of the deposit financial institution to configure an “override rule” for a deposit limit model, which may dictate that if the deposit limit calculated by the deposit limit model is outside the bounds of how the deposit limit value is permitted to change relative to the prior deposit limit value, then the calculated deposit limit may be overridden by some other value.

To illustrate with one example, an override rule could be configured that prevents the value of the deposit limit from decreasing during the given time window (e.g., the current month), in which case the deposit limit calculated by the deposit limit model would be overridden any time it is lower than the prior deposit limit value for the given time window. (However, in other implementations, this could be accomplished by including the current deposit limit as an input variable to the deposit limit model and specifying that the deposit limit is maximum of either the current deposit limit or an amount calculated based on one or more other input variables). In such an example, the deposit limit may then be permitted to decrease when transitioning to a new time window, or the override rule may continue to be applied during the transition to the new time window, among other possibilities.

To illustrate with another example, an override rule could be configured that prevents the value of the deposit limit from increasing or decreasing by more than a threshold extent (e.g., a threshold percentage or amount) from one update to another, in which case the deposit limit calculated by the deposit limit model would be overridden any time it exceeds the threshold extent (e.g., if deposit limit increases by more than the threshold extent, the updated deposit limit value may be set to an amount that corresponds to the threshold extent of increase).

Other examples of override rules are possible as well.

Further yet, in a scenario where the specified input variables for a deposit limit model include a “derived” input variable for which the computing platform 102 will need to derive the value based on the values of other underlying data variables, then the configuration GUI may enable the representative of the deposit financial institution to input configuration parameters that define the logic for deriving the value of the derived input variable. To illustrate with an example, if one of the specified input variables for a deposit limit model indicates the secured balance of the applicable deposit account(s) and the computing platform 102 needs to derive the value of that input variable at the time it utilizes the deposit limit model to determine the deposit limit because it is not otherwise available to the computing platform 102, then the configuration GUI could be utilized to defined the logic that is to be utilized by the computing platform 102 in order to derive the value of the input variable indicating the secure balance. In this respect, the configuration parameters for the logic that derives the value of a derived input variable may include (i) the one or more source variables for the derived input variable, (ii) weights for the source variables, and (iii) operators, among various other possible configuration parameters.

The GUI may enable the representative of the deposit financial institution to input other types of configuration parameters for a deposit limit model as well.

Another type of configuration setting that may be input using the configuration GUI may take the form of a setting that dictates when the initial and/or updated determinations of a deposit limit for an account holder are made. For instance, the configuration GUI may enable the representative of the deposit financial institution to specify that the initial determination of a deposit limit for an account holder be made either at or around the time that the account holder's first deposit account is opened, or at some later time. Further, the configuration GUI may enable the representative of the deposit financial institution to specify that the updated determinations of a deposit limit for an account holder be made (i) in accordance with a specified update frequency (e.g., every hour, every several hours, every day, every several days, etc.) and/or (ii) in response to specified types of trigger events (e.g., requests by the account holder to make new deposits or take other kinds of account actions, a request by an account holder for an increased deposit limit, etc.), among other possibilities.

The GUI may enable the representative of the deposit financial institution to input other types of configuration settings for the deposit limit engine 202 as well.

While the client device 110 is presenting the configuration GUI, the representative of the deposit financial institution may input any of the aforementioned types of configuration settings for the deposit limit engine 202. For instance, the representative of the deposit financial institution may specify that the deposit limits determined by the deposit limit engine 202 are to be applied to the current month and to a given class of deposits that includes certain types of higher-risk check and ACH-based deposits but excludes other types of lower-risk check and ACH-based deposits. Further, the representative of the deposit financial institution may input configuration parameters for two deposit limit models: (i) a first deposit limit model that is configured to determine a deposit limit for an account holder at a time when there is not sufficient deposit account history for the account holder and (ii) a second deposit limit model that is configured to determine a deposit limit for an account holder at a time when there is sufficient deposit account history for the account holder. In this respect, the first deposit limit model may be configured to have input variables related to the account holder's consumer history, personal background, and/or non-deposit financial accounts, but not any deposit accounts, whereas the second deposit limit model may be configured to have input variables related to the account holder's deposit accounts and perhaps also the account holder's consumer history. Further yet, the representative of the deposit financial institution may specify that the first deposit limit model is to be utilized to make initial determinations of a deposit limit at or around the time that an account holder opens a first deposit account and that the second deposit limit model is to be utilized to make updated determinations of a deposit limit in accordance with a daily frequency. Many other examples are possible as well.

Returning to FIG. 3, at block 304, the computing platform 102 may receive an indication of the configuration settings for the deposit limit engine 202. For instance, the client device 110 may receive the input of the configuration settings from the representative of the deposit financial institution, and the client device 110 may then transmit one or more data messages comprising data indicating the configuration settings to the computing platform 102 via a network-based communication path between the client device 110 and the computing platform 102. The computing platform 102 may receive the indication of the configuration settings for the deposit limit engine 202 in various other ways as well.

At block 306, the computing platform 102 may configure the deposit limit engine 202 based on the configuration settings that have been input by the representative of the deposit financial institution. For instance, the computing platform 102 may configure the deposit limit engine 202 to determine deposit limits that are to be applied to a given time window (e.g., the current month) and to a given class of deposits (e.g., certain types of higher-risk check and ACH-based deposits). Further, the computing platform 102 may configure the deposit limit engine 202 to determine deposit limits utilizing one or more deposit limit models, such as (i) a first deposit limit model that is configured to determine a deposit limit for an account holder at a time when there is not sufficient deposit account history for the account holder and (ii) a second deposit limit model that is configured to determine a deposit limit for an account holder at a time when there is sufficient deposit account history for the account holder. Further yet, the computing platform 102 may configure the deposit limit engine 202 to utilize the first deposit limit model to make initial determinations of a deposit limit at or around the time that an account holder opens a first deposit account and to utilize the second deposit limit model to make updated determinations of a deposit limit in accordance with a daily frequency. The function of configuring the deposit limit engine 202 based on the configuration settings may take other forms as well.

To illustrate with one specific example, a first deposit limit model could be configured to determine a deposit limit based on first set of input variables that indicate a credit score and a number of credit lines of an account holder, whereas a second deposit limit model could be configured to determine a deposit limit based on second set of input variables that indicate a total or average amount of direct deposits into the applicable deposit account(s) (which could be weighted by first value), a secured balance of the applicable deposit account(s) (which could be weighted by second value), and perhaps also a credit score of the account holder (which could be translated into a monetary value). Many other examples are possible as well.

While FIG. 3 illustrates an embodiment where the configuration settings of the deposit limit engine 202 are input by a representative of the deposit financial institution (e.g., the configuration settings are parameterized), in other embodiments, some or all of the configuration settings could be hardcoded into the deposit limit engine 202 rather than being defined based on user input. For instance, in other embodiments, any one or more of the given time window, the given class of deposits, the one or more deposit limit models, and/or the timing for making the initial and updated determinations (e.g., the update frequency) could be hardcoded into the deposit limit engine 202 rather than being based on user input.

The configuration settings of the deposit limit engine 202 could be defined in other manners as well.

Further, in other embodiments, the one or more deposit limit models disclosed herein could be created by applying a machine learning process to a training dataset, which may include historical data for the types of input variables described above and perhaps also corresponding ground-truth values for the type of deposit limit to be output by the deposit limit models, among other possibilities. In this respect, the machine learning process may involve functionality for training any of various types of models, examples of which may include a regression model, a decision-tree-based model (e.g., a gradient boosting model, random forest model, etc.), a support vector machines (SVM)-based model, a Bayesian model, a k-Nearest Neighbor (kNN) model, a Gaussian process model, a deep learning model (e.g., a feedforward, recurrent, or convolution neural-network model, a generative adversarial network (GAN) model, an autoencoder-based model, a transformer-based model, etc.), a clustering model, an association-rule model, a dimensionality-reduction model, and/or a reinforcement-learning model, among other possible examples of models that can be created using machine learning techniques.

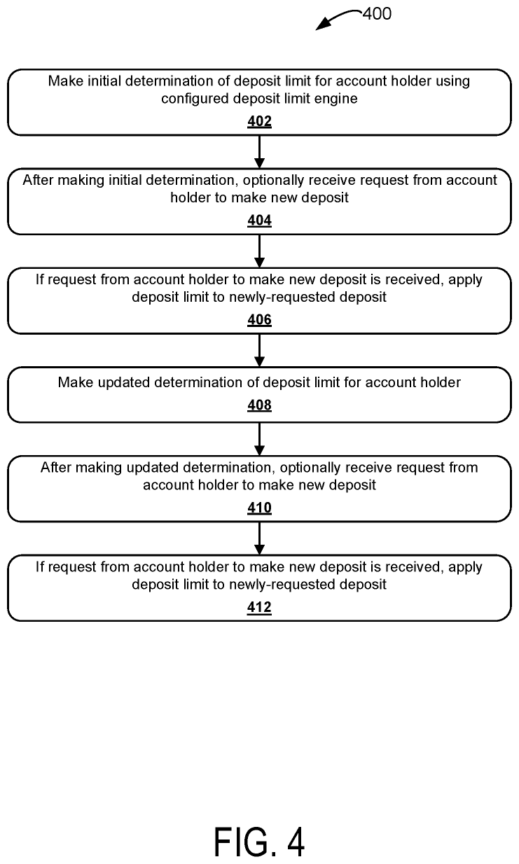

Turning next to FIG. 4, an example flow chart illustrating example functionality 400 for determining and applying a deposit limit in accordance with the present disclosure is shown. In practice, the example functionality 400 of FIG. 4 may be encoded in the form of program instructions that are executable by one or more processors of a computing platform, and for purposes of illustration, the example functionality 400 of FIG. 4 is described as being carried out by the computing platform 102 of FIG. 2 that has been installed with the example deposit limit engine 202, but it should be understood that the example functionality 400 of FIG. 4 may be carried out by any one or more computing platforms that are capable of being installed with software that provides the example functionality 400 of FIG. 4. Further, for purposes of illustration, the example functionality 400 of FIG. 4 is described with reference to one account holder of interest, but in practice, it should be understood that the example functionality 400 can (and likely will) be carried out for thousands or even millions of account holders. Further yet, it should be understood that the example functionality 400 of FIG. 4 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 4, the example functionality 400 may begin at block 402 with the computing platform 102 (which as noted above is installed with the example deposit limit engine 202) making an initial determination of a deposit limit for a given account holder-which constitutes a monetary limit on the cumulative amount of deposits of a given class (e.g., deposits that present a higher risk of return such as certain types of check deposits and/or ACH deposits) that the given account holder is permitted make during a given time window (e.g., the current month).

Depending on the configuration of the deposit limit engine 202 and the number of deposit accounts held by the given account holder, the deposit limit that is determined for the given account holder could be applicable to a single account or multiple accounts of the given account holder. For instance, if the given account holder has multiple deposit accounts with the deposit financial institution, then depending on the configuration of the deposit limit engine 202, the deposit limit determined for the given account holder either could be applicable to the cumulative amount of deposits across those multiple deposit accounts or could be applicable to a particular one of those multiple deposit accounts. On the other hand, if the given account holder only has a single deposit account with the deposit financial institution, then regardless of the configuration of the deposit limit engine 202, the deposit limit determined for the given account holder will be applicable to that one single deposit account.

The computing platform 102 may make the initial determination of the deposit limit for the given account holder at any of various times. For instance, as one possibility, the computing platform 102 may make the initial determination of the deposit limit for the given account holder at or around the time that the given account holder opens a first deposit account with the deposit financial institution—in which case the given account holder may not yet have any deposit account history with the deposit financial institution that is available for use in determining the deposit limit (although the given account holder could potentially have pre-existing financial accounts of other types with the deposit financial institution). As another possibility, the computing platform 102 may make the initial determination of the deposit limit for the given account holder at a time when the given account holder already has at least one deposit account with the deposit financial institution and there is available account history for the at least one deposit account. For example, the disclosed software technology for determining and applying deposit limits may first be implemented at the computing platform 102 at a time when there are already preexisting account holders of deposit accounts with the deposit financial institution, and the deposit financial institution may decide to determine deposit limits for some or all of those preexisting account holders-which could include the given account holder. As another example, the computing platform 102 may be configured such that, after the given account holder opens a first deposit account with the deposit financial institution, the computing platform 102 waits some amount of time before making the initial determination of the deposit limit for the given account holder so as to allow some deposit account history to develop for the given account holder. The computing platform 102 may make the initial determination of the deposit limit for the given account holder at other times as well.

Further, the functionality for making the initial determination of the deposit limit for the given account holder may take any of various forms, which may depend in part on the time when the initial determination is being made, the data related to the given account holder that is available to the computing platform 102, and/or the configuration of the deposit limit engine 202, among other possible factors.

According to one possible implementation, the functionality for making the initial determination of the deposit limit for the given account holder may begin with the computing platform 102 obtaining source data for making the initial determination of the deposit limit for the given account holder. The source data that is obtained may take various forms, which may depend on the particular input variables of the deposit limit model that will be utilized by the deposit limit engine 202 to make the initial determination of the deposit limit for the given account holder. For instance, in line with the discussion above, the deposit limit engine 202 may be operable to make the initial determination of the deposit limit using either a first deposit limit model if there is not sufficient deposit account history for the given account holder (e.g., the given account holder has recently opened a first deposit account with the deposit financial institution) or a second deposit limit model if there is sufficient deposit account history for the given account holder. In this respect, the source data that is obtained may comprise data for use in determining values for the input variables of either the first deposit limit model or the second deposit limit model.

More particularly, if the initial determination of the deposit limit is to be made using the first deposit limit model described above, then the source data that is obtained by the computing platform 102 may comprise data for use in determining values for the input variables of the first deposit limit model, which as noted above may include input variables related to the given account holder's consumer history, the given account holder's personal background, and/or the given account holder's other financial accounts (if any) with the deposit financial institution, among other possibilities. Examples of such source data may include a FICO credit score or other credit score provided by a consumer reporting agency or the like, a history of debt payments (e.g., credit line payments, loan payments, mortgage payments, etc.), an indication of the employment status and possibly level of income of the given account holder, among various other examples.

On the other hand, if the initial determination of the deposit limit is to be made using the second deposit limit model described above, then the source data that is obtained by the computing platform 102 may comprise data for use in determining values for the input variables of the second deposit limit model, which as noted above may include input variables related to given account holder's one or more deposit accounts and perhaps also input variables related to the given account holder's consumer history, the given account holder's personal background, and/or the given account holder's other financial accounts (if any) with the deposit financial institution, among other possibilities. Examples of such source data may include a current balance across one or more deposit accounts held by the given account holder at the deposit financial institution, recent deposit activity for deposits of the given class, a secured balanced across one or more deposit accounts held by the given account holder at the deposit financial institution, among various other examples, including any of the source data described with respect to determining values for input variables of the first deposit limit model.

The source data that is obtained by the computing platform 102 may take other forms as well. Further, the function of obtaining the source data may involve accessing the source data from the computing platform's data storage system, requesting and receiving the source data from a third-party data source (e.g., a computing platform of a credit bureau), or some combination thereof, among other possibilities.

After obtaining the source data for making the initial determination of the deposit limit for the given account holder, the computing platform 102 may then use the source data as a basis for obtaining the values for the input variables of the deposit limit model that will be utilized to make the initial determination of the deposit limit for the given account holder. Depending on the form of the source data and the input variables, this function of obtaining the values of the input variables based on the source data may take any of various forms. For instance, in a scenario where a given input variable's value is already itself included within the source data obtained by the computing platform 102, then the function of obtaining the given input variable's value based on the source data may be accomplished by obtaining the source data. Examples of input variables for which values may be obtained in this manner include an input variable indicating a current deposit limit that governs deposits of the given class for one or more accounts held by the given account holder at the deposit financial institution, and an input variable indicating a current balance in one or more deposit accounts held by the given account holder at the deposit financial institution, among various other examples.

On the other hand, in a scenario where a given input variable's value is not itself included within the source data obtained by the computing platform 102, then the function of obtaining the given input variable's value based on the source data may involve deriving that value based on available values for other data variables that are included within the source data. In this respect, as discussed above, the logic for deriving the given input variable's value from the source data could be defined as part of the configuration parameters for the deposit limit model to be utilized by the deposit limit engine 202, among other possible ways that the computing platform 102 may be configured to derive the given input variable's value from source data. Examples of input variables for which values may be obtained in this manner include an input variable indicating a credit score band of the given account holder and an input variable indicating a secured balance of the given account holder, among various other examples.

Next, the computing platform 102 may use the obtained values for the input variables and the applicable deposit limit model to make the initial determination of the deposit limit, which may involve inputting the obtained values for the input variables into the applicable deposit limit model and thereby causing the deposit limit model to output a deposit limit value for the given account holder. In this respect, depending on the configuration of the deposit limit model that is utilized, the deposit limit that is determined either could be a fixed value that is selected from some predefined set of fixed deposit limit values (e.g., a given tier) or could be a customized value for the given account holder, among other possibilities.

The functionality for making the initial determination of the deposit limit for the given account holder could take various other forms as well.

In line with the discussion above, after making the initial determination of the deposit limit for the given account holder, the computing platform 102 installed with the deposit limit engine 202 may also function to update the deposit limit for the given account holder in accordance with the update frequency (e.g., daily, weekly, monthly, etc.) and/or in response to certain triggering events (e.g., an account holder's request to make a new deposit, an account holder's request for an increased deposit limit, etc.). However, between the time that the computing platform 102 makes the initial determination of the deposit limit for the given account holder and the time that the computing platform 102 makes any updated determination of the deposit limit for the given account holder, it is possible that the given account holder could request to make a new deposit of a type that could potentially be governed by the given account holder's deposit limit—in which case the computing platform 102 may apply the initially-determined deposit limit to the newly-requested deposit.

For instance, at block 404, the computing platform 102 installed with the deposit limit engine 202 may optionally receive a request from the given account holder to make a new deposit at a time during the applicable time window that is after the deposit limit for the given account holder has initially been determined but before the deposit limit has been updated.

In turn, at block 406, the computing platform 102 installed with the deposit limit engine 202 may apply the initially-determined deposit limit to the newly-requested deposit, which may involve (i) determining whether the newly-requested deposit violates the initially-determined deposit limit, and then (ii) deciding how to handle the newly-requested deposit (e.g., whether to reject or accept the newly-requested deposit) based on the determining. This functionality may take various forms.

According to one possible implementation, the functionality for determining whether the newly-requested deposit violates the initially-determined deposit limit may begin with the computing platform 102 determining whether the newly-requested deposit falls within the given class of deposits that are governed by the deposit limit for the given account holder. In this respect, if the newly-requested deposit does not fall within the given class of deposits that are governed by the deposit limit, the computing platform 102 may determine that the newly-requested deposit does not violate the initially-determined deposit limit, and then decide to accept the newly-requested deposit. On the other hand, if the newly-requested deposit does fall within the given class of deposits that are governed by the deposit limit, the computing platform 102 may perform an evaluation of whether the newly-requested deposit will cause the given account holder's deposit activity for the applicable time window (e.g., the current month) to exceed the initially-determined deposit limit.

For instance, the computing platform 102 may start by determining a cumulative amount of deposits of the given class that will have been made by the given account holder into the applicable deposit account(s) within the applicable time window if the new deposit is permitted. To accomplish this, the computing platform 102 may take the amount of the newly-requested deposit and add it to the cumulative amount of deposits of the given class that have previously been made by the given account holder into the applicable deposit account(s) within the applicable time window-which may either be a value that the computing platform 102 determines and maintains on an ongoing basis as deposits are made or a value that the computing platform 102 calculates on an as-needed basis (e.g., based on accessing deposit account activity) when determining whether the deposit limit has been violated.

To illustrate with an example, if the cumulative amount of deposits of the given class that have already been made the given account holder into the applicable deposit account(s) within the applicable time window is $4500, and the newly-requested deposit is for an amount of $2000, then the computing platform 102 may calculate a cumulative amount of $6500 in deposits of the given class that will have been made by the given account holder into the applicable deposit account(s) within the applicable time window if the new deposit is permitted.

Next, the computing platform 102 may compare the updated cumulative amount of deposits against the initially-determined deposit limit for the given account holder. In this respect, if the updated cumulative amount of deposits exceeds the initially-determined deposit limit, then the computing platform 102 may determine that the newly-requested deposit violates the initially-determined deposit limit, and based on this determination, may decide to reject (or at least delay acceptance of) the newly-requested deposit. On the other hand, if the updated cumulative amount of deposits does not exceed the initially-determined deposit limit, then the computing platform 102 may determine that the newly-requested deposit does not violate the initially-determined deposit limit, and based on this determination, may decide to accept the newly-requested deposit.

Lastly, after deciding how to handle the newly-requested deposit based on the initially-determined deposit limit, the computing platform 102 may carry out any of various actions in accordance with that decision. For instance, if the computing platform 102 decides to reject the newly-requested deposit because it violates the initially-determined deposit limit, the computing platform 102 may then cause the given account holder to be presented with a notification that the newly-requested deposit has been rejected due to a violation of the initially-determined deposit limit, among other possible actions that may be carried out the computing platform 102 in accordance with a decision to reject the newly-requested deposit. On the other hand, if the computing platform 102 decides to accept the newly-requested deposit because it does not violate the initially-determined deposit limit, the computing platform 102 may then proceed with processing the newly-requested deposit, which may involve processing functionality similar to that describe above in connection with FIG. 1. The actions that are carried by the computing platform 102 in accordance with its handling decision for the newly-requested deposit may take other forms as well.

The computing platform 102 may thereafter repeat the functionality of blocks 404 and 406 for any other deposits that are requested by the given account holder between the time that the computing platform 102 makes the initial determination of the deposit limit for the given account holder and the time that the computing platform 102 updates the deposit limit for the given account holder.

To illustrate the foregoing functionality of blocks 402-406 with an example, the computing platform 102 could initially determine a deposit limit of $1000 for the given account holder that is applicable to deposits of the given class (e.g., deposit types that present an increased risk of return) that are made into any of the given account holder's deposit accounts during the current month. At a first point in time during the current month that is after the initial determination of the deposit limit but before the deposit limit is updated, the computing platform 102 could receive a first request from the given account holder to make a $500 check deposit into one of the given account holder's deposit accounts. In this scenario, because this is the first deposit request of the current month, the computing platform 102 may then compare a cumulative deposit amount of $500 against the given account holder's current $1000 deposit limit, and based on that comparison, the computing platform 102 may determine that the $1000 deposit limit is not violated and accept the $500 check deposit. At a second point in time during the same current month that is after the initial determination of the deposit limit but before the deposit limit is updated, the computing platform 102 could also receive a second request from the given account holder to make a $600 check deposit into one of the given account holder's deposit accounts. In this scenario, the computing platform 102 may calculate an updated cumulative amount of deposits of the given class to be $1100 (inclusive of the second deposit), and based on a comparison between the updated cumulative deposit amount of $1100 and the given account holder's current $1000 deposit limit, the computing platform 102 may determine that the deposit limit has been violated and decide to reject the second deposit.

It should be understood that this is merely one illustrative example, and that various other examples are possible as well-including but not limited to the possibility that the computing platform 102 does not receive any deposit requests during the given time window between the time that the computing platform 102 makes the initial determination of the deposit limit for the given account holder and the time that the computing platform 102 updates the deposit limit for the given account holder, and thus does not carry out the functionality of blocks 404-406.

At block 408, the computing platform 102 installed with the deposit limit engine 202 may then make an updated determination of the deposit limit for the given account holder. In practice, the computing platform 102 may make the updated determination of the deposit limit for the given account holder at any of various times. For instance, as one possibility, the computing platform 102 may make the updated determination of the deposit limit for the given account holder at a time where the given account holder may not yet have any deposit account history with the deposit financial institution that is available for use in determining the deposit limit (although the given account holder could potentially have pre-existing financial accounts of other types with the deposit financial institution). As another possibility, the computing platform 102 may make the updated determination of the deposit limit for the given account holder at a time when the given account holder already has at least one deposit account with the deposit financial institution and there is available account history for the at least one deposit account. The computing platform 102 may make the updated determination of the deposit limit for the given account holder at other times as well.

Further, the functionality for making the updated determination of the deposit limit for the given account holder may take any of various forms, which may depend in part on the time when the updated determination is being made, the data related to the given account holder that is available to the computing platform 102, and/or the configuration of the deposit limit engine 202, among other possible factors.

According to one possible implementation, the functionality for making the updated determination of the deposit limit for the given account holder may begin with the computing platform 102 obtaining source data for making the updated determination of the deposit limit for the given account holder. The source data that is obtained may take various forms, which may depend on the particular input variables of the deposit limit model that will be utilized by the deposit limit engine 202 to make the updated determination of the deposit limit for the given account holder. For instance, in line with the discussion above, the deposit limit engine 202 may be operable to make the updated determination of the deposit limit using either a first deposit limit model if there is not sufficient deposit account history for the given account holder (e.g., the given account holder has recently opened a first deposit account with the deposit financial institution) or a second deposit limit model if there is sufficient deposit account history for the given account holder. In this respect, the source data that is obtained may comprise data for use in determining values for the input variables of either the first deposit limit model or the second deposit limit model.

More particularly, if the updated determination of the deposit limit is to be made using the first deposit limit model described above, then the source data that is obtained by the computing platform 102 may comprise data for use in determining values for the input variables of the first deposit limit model, which as noted above may include input variables related to the given account holder's consumer history, the given account holder's personal background, and/or the given account holder's other financial accounts (if any) with the deposit financial institution, among other possibilities.

On the other hand, if the updated determination of the deposit limit is to be made using the second deposit limit model described above, then the source data that is obtained by the computing platform 102 may comprise data for use in determining values for the input variables of the second deposit limit model, which as noted above may include input variables related to given account holder's one or more deposit accounts and perhaps also input variables related to the given account holder's consumer history, the given account holder's personal background, and/or the given account holder's other financial accounts (if any) with the deposit financial institution, among other possibilities.

The source data that is obtained by the computing platform 102 may take other forms as well.

After obtaining the source data for making the updated determination of the deposit limit for the given account holder, the computing platform 102 may then use the source data as a basis for obtaining the values for the input variables of the deposit limit model that will be utilized to make the updated determination of the deposit limit for the given account holder, which may be similar to the manner previously described with respect to obtaining the values for the input variables of the deposit limit model that will be utilized to make the initial determination of the deposit limit for the given account holder.

Next, the computing platform 102 may use the obtained values for the input variables and the applicable deposit limit model to make the updated determination of the deposit limit, which may involve inputting the determined values for the input variables into the applicable deposit limit model and thereby causing the deposit limit model to output a deposit limit value for the given account holder. In this respect, depending on the configuration of the deposit limit model that is utilized, the deposit limit that is determined either could be a fixed value that is selected from some predefined set of fixed deposit limit values (e.g., a given tier) or could be a customized value for the given account holder, among other possibilities.

Further, in some implementations, the function of making the updated determination of the deposit limit may also involve the application of certain override rules. For example, the computing platform 102 may apply an override rule dictating that an updated deposit limit value cannot be lower than a previously-determined deposit limit value for the same time window, which may result in the updated value of the deposit limit being the same as the prior value of the deposit limit. (However, as noted above, this could alternatively be accomplished by including the current deposit limit as an input variable to the deposit limit model and specifying that the deposit limit is maximum of either the current deposit limit or an amount calculated based on one or more other input variables). When such an override rule is applied, the computing platform 102 could then optionally be configured to reset the deposit limit to a lower value at some point in the future if the updated determinations of the deposit limit continue to produce in a lower deposit limit value—such as at the beginning of the next time window (e.g., the next month). To improve customer experience, the computing platform 102 could also optionally be configured to provide the given account holder with advance notice that the deposit limit may be set to decrease to a lower value at some point in the future.

As another example, the computing platform 102 may apply an override rule dictating that an updated deposit limit value cannot increase or decrease by more than a threshold extent (e.g., a threshold percentage or amount), which may result in the updated value of the deposit limit being set to an amount that corresponds to the threshold extent of change permitted by the override rule (e.g., if the override rule permits a 5% increase and the value increases by more than 5%, then the updated value is set to the amount that corresponds to the 5% increase).

The functionality for making the updated determination of the deposit limit for the given account holder could take various other forms as well.

In line with the discussion above, after making the updated determination of the deposit limit for the given account holder, the computing platform 102 installed with the deposit limit engine 202 may also function to update the deposit limit for the given account holder again in accordance with the update frequency and/or in response to certain triggering events. However, between any two updates of the deposit limit that are made for the given account holder, it is possible that the given account holder could request to make a new deposit of a type that could potentially be governed by the given account holder's deposit limit—in which case the computing platform 102 may apply the updated deposit limit to the newly-requested deposit.

For instance, at block 410, the computing platform 102 installed with the deposit limit engine 202 may optionally receive a request from the given account holder to make a new deposit at a time during the applicable time window that is after the deposit limit for the given account holder has been updated a first time but before the deposit limit has been updated a second time.

In turn, at block 412, the computing platform 102 installed with the deposit limit engine 202 may apply the updated deposit limit to the newly-requested deposit, which may involve (i) determining whether the newly-requested deposit violates the updated deposit limit, and then (ii) deciding how to handle the newly-requested deposit (e.g., whether to reject or accept the newly-requested deposit) based on the determining. In practice, this functionality may take various forms and may be similar to the functionality described with respect to block 406.

In particular, according to one possible implementation, the functionality for determining whether the newly-requested deposit violates the updated deposit limit may begin with the computing platform 102 determining whether the newly-requested deposit falls within the given class of deposits that are governed by the deposit limit for the given account holder. In this respect, if the newly-requested deposit does not fall within the given class of deposits that are governed by the deposit limit, the computing platform 102 may determine that the newly-requested deposit does not violate the updated deposit limit, and then decide to accept the newly-requested deposit. On the other hand, if the newly-requested deposit does fall within the given class of deposits that are governed by the deposit limit, the computing platform 102 may perform an evaluation of whether the newly-requested deposit will cause the given account holder's deposit activity for the applicable time window (e.g., the current month) to exceed the updated deposit limit.

For instance, the computing platform 102 may start by determining a cumulative amount of deposits of the given class that will have been made by the given account holder into the applicable deposit account(s) within the applicable time window if the new deposit is permitted. To accomplish this, the computing platform 102 may take the amount of the newly-requested deposit and add it to the cumulative amount of deposits of the given class that have previously been made by the given account holder into the applicable deposit account(s) within the applicable time window-which may either be a value that the computing platform 102 determines and maintains on an ongoing basis as deposits are made or a value that the computing platform 102 calculates on an as-needed basis (e.g., based on accessing deposit account activity) when determining whether the deposit limit has been violated.

Next, the computing platform 102 may compare the updated cumulative amount of deposits against the updated deposit limit for the given account holder. In this respect, if the updated cumulative amount of deposits exceeds the updated deposit limit, then the computing platform 102 may determine that the newly-requested deposit violates the updated deposit limit, and based on this determination, may decide to reject (or at least delay acceptance of) the newly-requested deposit. On the other hand, if the updated cumulative amount of deposits does not exceed the updated deposit limit, then the computing platform 102 may determine that the newly-requested deposit does not violate the updated deposit limit, and based on this determination, may decide to accept the newly-requested deposit.

Lastly, after deciding how to handle the newly-requested deposit based on the updated deposit limit, the computing platform 102 may carry out any of various actions in accordance with that decision. For instance, if the computing platform 102 decides to reject the newly-requested deposit because it violates the updated deposit limit, the computing platform 102 may then cause the given account holder to be presented with a notification that the newly-requested deposit has been rejected due to a violation of the updated deposit limit, among other possible actions that may be carried out the computing platform 102 in accordance with a decision to reject the newly-requested deposit. On the other hand, if the computing platform 102 decides to accept the newly-requested deposit because it does not violate the updated deposit limit, the computing platform 102 may then proceed with processing the newly-requested deposit, which may involve processing functionality similar to that describe above in connection with FIG. 1. The actions that are carried by the computing platform 102 in accordance with its handling decision for the newly-requested deposit may take other forms as well.

Further, it should be understood that the computing platform 102 installed with the deposit limit engine 202 may repeat operations of blocks 410-412 for any other deposits that are requested by the given account holder between the time that the deposit limit for the given account holder is updated the first time and the time that the deposit limit is updated a second time.

To illustrate the foregoing functionality of blocks 408-412 with an example, the computing platform 102 could determine an updated amount of $1200 for a deposit limit of the given account holder that is applicable to deposits of the given class (e.g., deposit types that present an increased risk of return) that are made into any of the given account holder's deposit accounts during the current month. At a first point in time during the given month after the updated determination of the deposit limit but before the deposit limit is again updated, the computing platform 102 could receive a first request from the given account holder to make a $500 check deposit into one of the given account holder's deposit accounts. In this scenario, because this is the first deposit request of the current month, the computing platform 102 may then compare a cumulative deposit amount of $500 against the given account holder's current $1200 deposit limit, and based on that comparison, the computing platform 102 may determine that the $1200 deposit limit is not violated and accept the $500 check deposit. At a second point in time during the same current month that is after the updated determination of the deposit limit but before the deposit limit is again updated, the computing platform 102 could also receive a second request from the given account holder to make a $600 check deposit into one of the given account holder's deposit accounts. In this scenario, the computing platform 102 may calculate a cumulative amount of deposits of the given class to be $1100 (inclusive of the second deposit), and based on a comparison between cumulative deposit amount of $1100 and the given account holder's current $1200 deposit limit, the computing platform 102 may determine that the deposit limit is not violated and decide to accept the second deposit. Then, at a third point in time during the same current month that is after the second point in time, the computing platform 102 may again update the deposit limit to a value of $2000. Then, at a fourth point in time during the same current month that is after the computing platform 102 updated the deposit limit to $2000, the deposit limit engine 202 may receive a third request from the given account holder to make another $500 check deposit into one of the given account holder's deposit accounts. In this scenario, the computing platform 102 may calculate a cumulative amount of deposits of the given class to be $1600 (inclusive of the third deposit), and based on a comparison between the cumulative amount of $1600 and the given account holder's current $2000 deposit limit, the computing platform may determine that the deposit limit has not been violated and accept the $500 check deposit.

It should be understood that this is merely one illustrative example, and that various other examples are possible as well-including but not limited to the possibility that the computing platform 102 does not receive any deposit requests during the given time window between the time that the computing platform 102 makes the updated determination of the deposit limit as described with reference to block 408 and makes a next updated determination of the deposit limit, and thus does not carry out the functionality of blocks 410-412.

After making the updated determination of the deposit limit at block 408 and optionally receiving and evaluating a deposit request at blocks 410-412, the computing platform 102 may then continue to make updated determinations of the deposit limit in accordance with the update frequency and/or in response to trigger events up through the end of the given time window. And when the given time window is at an end, the computing platform 102 installed with the deposit limit engine 202 may then switch to applying the deposit limit to a new given time window (e.g., the next month) and “reset” the cumulative amount of deposits to which the deposit limit applies to $0. In this respect, the computing platform 102 may continue to make updated determinations of the deposit limit utilizing the same deposit limit model, although as noted above, it is possible that the computing platform 102 may allow the deposit limit to change in certain ways between time windows that may not otherwise be permitted during a single time window. For example, in some implementations, the computing platform 102 may be configured with an override rule that prohibits a deposit limit from decreasing during the given time window, but that override rule may permit a deposit limit to decrease (at least by some amount) at the beginning of a new time window.

Further, in addition to determining deposit limits, in some implementations, the computing platform 102 may cause the given account holder to be presented with one or more notifications regarding the deposit limit. As one example, as previously described, the computing platform 102 may cause the given account holder to be presented with a notification that a newly-requested deposit has been rejected due to a violation of a deposit limit. As another example, the deposit limit engine 202 may cause the given account holder to be presented with a notification to inform the given account holder of one or more potential solutions for making a deposit such that the deposit will not violate a deposit limit applied to the given account holder. As one option, the notification may inform the given account holder how they might request the deposit so that the deposit is not of the given class of deposits that are governed by the deposit limit (e.g., by requesting the deposit in-person at a service location of the deposit financial institution. As another option, the notification may inform the given account holder of when a request for the deposit can be made without violating a deposit limit (e.g., at a subsequent time window). As yet another option, the notification may inform the given account holder of possible actions that the given account holder might take to increase their deposit limit (e.g., by increasing their tenure with the deposit financial institution, by improving their credit score, etc.). Various other possibilities may also exist.

While FIG. 4 describes one possible embodiment of the functionality for determining and applying a deposit limit for an account holder, in other embodiments, the functionality for determining and applying a deposit limit for an account holder could take other forms as well.

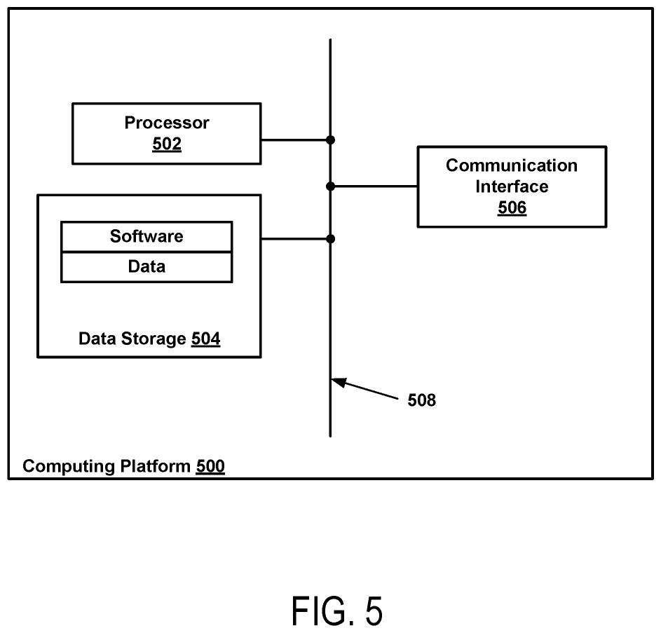

Turning now to FIG. 5, a simplified block diagram is provided to illustrate some structural components that may be included in an example computing platform 500 that may be configured to perform some or all of the platform functions disclosed herein. At a high level, the example computing platform 500 may generally comprise any one or more computer systems (e.g., one or more servers) that collectively include one or more processors 502, data storage 504, and one or more communication interfaces 506, all of which may be communicatively linked by a communication link 508 that may take the form of a system bus, a communication network such as a public, private, or hybrid cloud, or some other connection mechanism. Each of these components may take various forms.

For instance, the one or more processors 502 may comprise one or more processor components, such as one or more central processing units (CPUs), graphics processing unit (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 502 could comprise processing components that are distributed across a plurality of physical computing devices connected via a network, such as a computing cluster of a public, private, or hybrid cloud.

In turn, the data storage 504 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 504 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 5, the data storage 504 may be capable of storing both (i) program instructions that are executable by the one or more processors 502 such that the example computing platform 500 is configured to perform any of the various functions disclosed herein (including but not limited to any of the platform functions discussed above), and (ii) data that may be received, derived, or otherwise stored by the example computing platform 500.

The one or more communication interfaces 506 may comprise one or more interfaces that facilitate communication between the example computing platform 500 and other systems or devices, where each such interface may be wired and/or wireless and may communicate according to any of various communication protocols. As examples, the one or more communication interfaces 506 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 500 may additionally have an I/O interface that includes or provides connectivity to I/O components that facilitate user interaction with the example computing platform 500, such as a keyboard, a mouse, a trackpad, a display screen, a touch-sensitive interface, a stylus, a virtual-reality headset, and/or one or more speaker components, among other possibilities.

It should be understood that the example computing platform 500 is one example of a computing platform that may be used with the embodiments described herein. Numerous other arrangements are possible and contemplated herein. For instance, in other embodiments, the example computing platform 500 may include additional components not pictured and/or more or less of the pictured components.

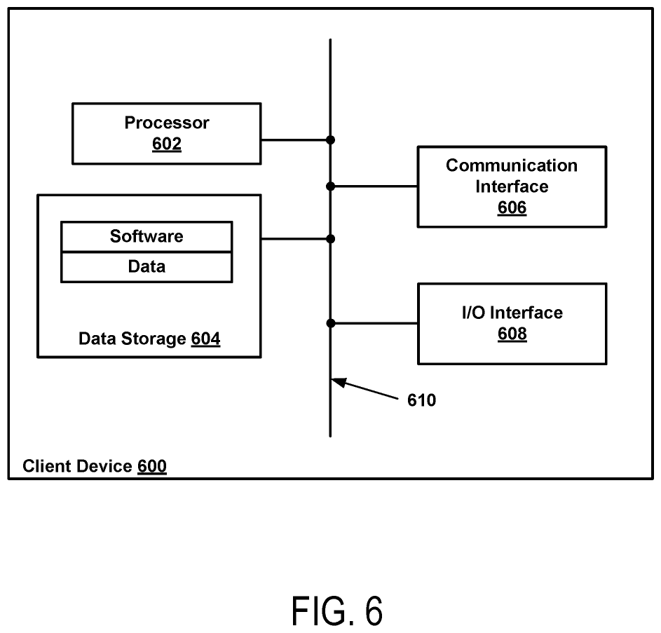

Turning next to FIG. 6, a simplified block diagram is provided to illustrate some structural components that may be included in an example client device 600 that may be configured to perform some or all of the client-device functions disclosed herein. At a high level, the example client device 600 may include one or more processors 602, data storage 604, one or more communication interfaces 606, and an I/O interface 608, all of which may be communicatively linked by a communication link 610 that may take the form a system bus and/or some other connection mechanism. Each of these components may take various forms.

For instance, the one or more processors 602 of the example client device 600 may comprise one or more processor components, such as one or more CPUs, GPUs, ASICs, DSPs, and/or programmable logic devices such as FPGAs, among other possible types of processing components.

In turn, the data storage 604 of the example client device 600 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 6, the data storage 604 may be capable of storing both (i) program instructions that are executable by the one or more processors 602 of the example client device 600 such that the example client device 600 is configured to perform any of the various functions disclosed herein (including but not limited to any of the client-device functions discussed above), and (ii) data that may be received, derived, or otherwise stored by the example client device 600.

The one or more communication interfaces 606 may comprise one or more interfaces that facilitate communication between the example client device 600 and other systems or devices, where each such interface may be wired and/or wireless and may communicate according to any of various communication protocols. As examples, the one or more communication interfaces 606 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 608 may generally take the form of (i) one or more input interfaces that are configured to receive and/or capture information at the example client device 600 and (ii) one or more output interfaces that are configured to output information from the example client device 600 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 608 may include or provide connectivity to output components such as a display screen and/or an audio speaker, among other possibilities.

It should be understood that the example client device 600 is one example of a client device that may be used with the example embodiments described herein. Numerous other arrangements are possible and contemplated herein. For instance, in other embodiments, the example client device 600 may include additional components not pictured and/or more or fewer of the pictured components.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform associated with a financial institution, the computing platform comprising:
at least one network interface;
at least one processor;
data storage comprising at least one non-transitory computer-readable medium; and
program instructions stored on the data storage that, when executed by the at least one processor, cause the computing platform to:
define first and second deposit limit models for determining, for any given account holder of a group of account holders that each holds one or more deposit accounts at the financial institution, a deposit limit for the given account holder that comprises a monetary limit on a cumulative amount of deposits within a given class that the given account holder is permitted to make into one or more deposit accounts during a given time window, wherein:
the first deposit limit model functions to (i) receive data for a first set of one or more data variables that provides consumer-history information but not deposit-account-activity information for the given account holder, and (ii) based on the received data for the first set of one or more data variables, determine the deposit limit for the given account holder, wherein the first deposit limit model is to be utilized at times when there is not sufficient deposit-account activity available for the given account holder; and
the second deposit limit model functions to (i) receive data for a second set of one or more data variables that provides deposit-account-activity information for the given account holder, and (ii) based on the received data for the second set of one or more data variables, determine the deposit limit for the given account holder, wherein the second deposit limit model is to be utilized at times when there is sufficient deposit-account activity available for the given account holder; and
for each respective account holder of the group of account holders:
at a first time when there is not sufficient deposit-account activity available for the respective account holder, use the first deposit limit model to determine a first value of the deposit limit for the respective account holder;
receive, from a first client device associated with the respective account holder, an indication of a request from the respective account holder to make a first new deposit into the respective account holder's one or more deposit accounts;
determine that the first new deposit is within the given class of deposits;
in response to determining that the first new deposit is within the given class of deposits:
determine whether the first value of the deposit limit for the respective account holder is violated by the first new deposit; and
either (i) accept the first new deposit if the first value of the deposit limit for the respective account holder is not violated by the first new deposit by initiating electronic processing of the first new deposit or (ii) reject the first new deposit if the first value of the deposit limit for the respective account holder is violated by the first new deposit by blocking the electronic processing of the first new deposit;
after the first time, make a determination that there is sufficient deposit-account activity for the respective account holder such that the second deposit limit model is to be utilized instead of the first deposit limit model;
at a second time that is after the determination that there is sufficient deposit-account activity for the respective account holder, use the second deposit limit model to determine a second value of the deposit limit for the respective account holder;
receive, from a second client device associated with the respective account holder, an indication of a request from the respective account holder to make a second new deposit into the respective account holder's one or more deposit accounts;
determine that the second new deposit is within the given class of deposits; and
in response to determining that the second new deposit is within the given class of deposits:
determine whether the second value of the deposit limit for the respective account holder is violated by the second new deposit; and
either (i) accept the second new deposit if the second value of the deposit limit for the respective account holder is not violated by the second new deposit by initiating electronic processing of the second new deposit or (ii) reject the second new deposit if the second value of the deposit limit for the respective account holder is violated by the second new deposit by blocking the electronic processing of the second new deposit.

2. The computing platform of claim 1, further comprising program instructions stored on the data storage that, when executed by the at least one processor, cause the computing platform to, for each respective account holder of the group of account holders:
at a third time that is after the second time, use the second deposit limit model to determine a third value of the deposit limit for the respective account holder based on updated data related to the respective account holder.

3-5. (canceled)

6. The computing platform of claim 1, wherein at least one of the first or second deposit limit models comprises (i) a respective set of input variables, (ii) one or more respective weight values corresponding to one or more of the respective set of input variables, and (iii) one or more respective operators.

7. The computing platform of claim 1, wherein (i) the first value of the deposit limit comprises a first fixed value that is selected from a first predefined set of deposit limit tiers, or (ii) the second value of the deposit limit comprises a second fixed value that is selected from a second predefined set of deposit limit tiers.

8. The computing platform of claim 1, wherein (i) the first value of the deposit limit comprises a first customized value that is computed for the respective account holder, or (ii) the second value of the deposit limit comprises a second customized value that is computed for the respective account holder.

9. The computing platform of claim 1, further comprising program instructions stored on the data storage that, when executed by the at least one processor, cause the computing platform to:
configure at least one of the first or second the given deposit limit models based on respective configuration settings that are specified by a representative of the financial institution.

10. The computing platform of claim 1, wherein at least one of the data received by the first deposit limit model or the data received by the second deposit limit model includes one or more of (i) data that is retrieved from the data storage, (ii) data that is received from a third-party data source, or (iii) data that is derived from source data.

11. A non-transitory computer-readable medium, wherein the non-transitory computer-readable medium is provisioned with program instructions that, when executed by at least one processor, cause a computing platform associated with a financial institution to:
define first and second deposit limit models for determining, for any given account holder of a group of account holders that each holds one or more deposit accounts at the financial institution, a deposit limit for the given account holder that comprises a monetary limit on a cumulative amount of deposits within a given class that the given account holder is permitted to make into one or more deposit accounts during a given time window, wherein:
the first deposit limit model functions to (i) receive data for a first set of one or more data variables that provides consumer-history information but not deposit-account-activity information for the given account holder, and (ii) based on the received data for the first set of one or more data variables, determine the deposit limit for the given account holder, wherein the first deposit limit model is to be utilized at times when there is not sufficient deposit-account activity available for the given account holder; and
the second deposit limit model functions to (i) receive data for a second set of one or more data variables that provides deposit-account-activity information for the given account holder, and (ii) based on the received data for the second set of one or more data variables, determine the deposit limit for the given account holder, wherein the second deposit limit model is to be utilized at times when there is sufficient deposit-account activity available for the given account holder; and
for each respective account holder of the group of account holders:
at a first time when there is not sufficient deposit-account activity available for the respective account holder, use the first deposit limit model to determine a first value of the deposit limit for the respective account holder;
receive, from a first client device associated with the respective account holder, an indication of a request from the respective account holder to make a first new deposit into the respective account holder's one or more deposit accounts;
determine that the first new deposit is within the given class of deposits;
in response to determining that the first new deposit is within the given class of deposits:
determine whether the first value of the deposit limit for the respective account holder is violated by the first new deposit; and
either (i) accept the first new deposit if the first value of the deposit limit for the respective account holder is not violated by the first new deposit by initiating electronic processing of the first new deposit or (ii) reject the first new deposit if the first value of the deposit limit for the respective account holder is violated by the first new deposit by blocking the electronic processing of the first new deposit;
after the first time, make a determination that there is sufficient deposit-account activity for the respective account holder such that the second deposit limit model is to be utilized instead of the first deposit limit model;
at a second time that is after the determination that there is sufficient deposit-account activity for the respective account holder, use the second deposit limit model to determine a second value of the deposit limit for the respective account holder;
receive, from a second client device associated with the respective account holder, an indication of a request from the respective account holder to make a second new deposit into the respective account holder's one or more deposit accounts;
determine that the second new deposit is within the given class of deposits; and
in response to determining that the second new deposit is within the given class of deposits:
determine whether the second value of the deposit limit for the respective account holder is violated by the second new deposit; and
either (i) accept the second new deposit if the second value of the deposit limit for the respective account holder is not violated by the second new deposit by initiating electronic processing of the second new deposit or (ii) reject the second new deposit if the second value of the deposit limit for the respective account holder is violated by the second new deposit by blocking the electronic processing of the second new deposit.

12. The non-transitory computer-readable medium of claim 11, wherein the non-transitory computer-readable medium is also provisioned with program instructions that, when executed by at least one processor, cause the computing platform to, for each respective account holder of the group of account holders:
at a third time that is after the second time, use the second deposit limit model to determine a third value of the deposit limit for the respective account holder based on updated data related to the respective account holder.

13-15. (canceled)

16. The non-transitory computer-readable medium of claim 11, wherein at least one of the first or second deposit limit models comprises (i) a respective set of input variables, (ii) one or more respective weight values corresponding to one or more of the respective set of input variables, and (iii) one or more respective operators.

17. The non-transitory computer-readable medium of claim 11, wherein (i) the first value of the deposit limit comprises a first fixed value that is selected from a first predefined set of deposit limit tiers, or (ii) the second value of the deposit limit comprises a second fixed value that is selected from a second predefined set of deposit limit tiers.

18. The non-transitory computer-readable medium of claim 11, wherein (i) the first value of the deposit limit comprises a first customized value that is computed for the respective account holder, or (ii) the second value of the deposit limit comprises a second customized value that is computed for the respective account holder.

19. The non-transitory computer-readable medium of claim 11, wherein the non-transitory computer-readable medium is also provisioned with program instructions that, when executed by at least one processor, cause the computing platform to:
configure at least one of the first or second deposit limit models based on respective configuration settings that are specified by a representative of the financial institution.

20. A method implemented by a computing platform associated with a financial institution, the method comprising:
defining first and second deposit limit models for determining, for any given account holder of a group of account holders that each holds one or more deposit accounts at the financial institution, a deposit limit for the given account holder that comprises a monetary limit on a cumulative amount of deposits within a given class that the given account holder is permitted to make into one or more deposit accounts during a given time window, wherein:
the first deposit limit model functions to (i) receive data for a first set of one or more data variables that provides consumer-history information but not deposit-account-activity information for the given account holder, and (ii) based on the received data for the first set of one or more data variables, determine the deposit limit for the given account holder, wherein the first deposit limit model is to be utilized at times when there is not sufficient deposit-account activity available for the given account holder; and
the second deposit limit model functions to (i) receive data for a second set of one or more data variables that provides deposit-account-activity information for the given account holder, and (ii) based on the received data for the second set of one or more data variables, determine the deposit limit for the given account holder, wherein the second deposit limit model is to be utilized at times when there is sufficient deposit-account activity available for the given account holder; and
for each respective account holder of the group of account holders:
at a first time when there is not sufficient deposit-account activity available for the respective account holder, using the first deposit limit model to determine a first value of the deposit limit for the respective account holder;
receiving, from a first client device associated with the respective account holder, an indication of a request from the respective account holder to make a first new deposit into the respective account holder's one or more deposit accounts;
determining that the first new deposit is within the given class of deposits;
in response to determining that the first new deposit is within the given class of deposits:
determining whether the first value of the deposit limit for the respective account holder is violated by the first new deposit; and
either (i) accepting the first new deposit if the first value of the deposit limit for the respective account holder is not violated by the first new deposit by initiating electronic processing of the first new deposit or (ii) rejecting the first new deposit if the first value of the deposit limit for the respective account holder is violated by the first new deposit by blocking the electronic processing of the first new deposit;
after the first time, making a determination that there is sufficient deposit-account activity for the respective account holder such that the second deposit limit model is to be utilized instead of the first deposit limit model;
at a second time that is after the determination that there is sufficient deposit-account activity for the respective account holder, using the second deposit limit model to determine a second value of the deposit limit for the respective account holder;
receiving, from a second client device associated with the respective account holder, an indication of a request from the respective account holder to make a second new deposit into the respective account holder's one or more deposit accounts;
determining that the second new deposit is within the given class of deposits; and
in response to determining that the second new deposit is within the given class of deposits:
determining whether the second value of the deposit limit for the respective account holder is violated by the second new deposit; and
either (i) accepting the second new deposit if the second value of the deposit limit for the respective account holder is not violated by the second new deposit by initiating electronic processing of the second new deposit or (ii) rejecting the second new deposit if the second value of the deposit limit for the respective account holder is violated by the second new deposit by blocking the electronic processing of the second new deposit.

21. The method of claim 20, further comprising, for each respective account holder of the group of account holders:
at a third time that is after the second time, using the second deposit limit model to determine a third value of the deposit limit for the respective account holder based on updated data related to the respective account holder.

22. The method of claim 20, wherein at least one of the first or second deposit limit models comprises (i) a respective set of input variables, (ii) one or more respective weight values corresponding to one or more of the respective set of input variables, and (iii) one or more respective operators.

23. The method of claim 20, wherein (i) the first value of the deposit limit comprises a first fixed value that is selected from a first predefined set of deposit limit tiers, or (ii) the second value of the deposit limit comprises a second fixed value that is selected from a second predefined set of deposit limit tiers.

24. The computing platform of claim 1, further comprising program instructions stored on the data storage that, when executed by the at least one processor, cause the computing platform to:
receive, from a third client device associated with the respective account holder, an indication of a request from the respective account holder to make a third new deposit into the respective account holder's one or more deposit accounts;
determine that the third new deposit is not within the given class of deposits; and
based on the determination that the third new deposit is not within the given class of deposits, handle the third new deposit without applying the deposit limit.

25. The non-transitory computer-readable medium of claim 11, wherein the non-transitory computer-readable medium is also provisioned with program instructions that, when executed by at least one processor, cause the computing platform to:
receive, from a third client device associated with the respective account holder, an indication of a request from the respective account holder to make a third new deposit into the respective account holder's one or more deposit accounts;
determine that the third new deposit is not within the given class of deposits; and
based on the determination that the third new deposit is not within the given class of deposits, handle the third new deposit without applying the deposit limit.

26. The method of claim 20, further comprising:
receiving, from a third client device associated with the respective account holder, an indication of a request from the respective account holder to make a third new deposit into the respective account holder's one or more deposit accounts;
determining that the third new deposit is not within the given class of deposits; and
based on the determination that the third new deposit is not within the given class of deposits, handling the third new deposit without applying the deposit limit.
